(19) United States
(12) Patent Application Publication
(10) Pub. No.: US 2007/0291652 A1
(43) Pub. Date: Dec. 20, 2007

(54) TRANSMITTING APPARATUS, TRANSMITTING-APPARATUS TESTING METHOD, AND COMPUTER PROGRAM PRODUCT

(75) Inventor: Hisashi OYAMADA, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/845,230

(22) Filed: Aug. 27, 2007

Related U.S. Application Data
(63) Continuation of application No. PCT/JP2005/003401, filed on Mar. 1, 2005.

(51) Int. Cl. H04J 1/16

(52) U.S. Cl. 370/250

(57) ABSTRACT

An information storing unit stores therein information on a connection status of transmitting apparatuses in a network and a usage status of a line between the transmitting apparatuses as access-path detecting information. A path establishing unit establishes a test communication path having a predetermined bandwidth for a test communication between a test-access testing facility and a target transmitting apparatus to be tested by the test-access testing facility via the network, based on the access-path detecting information stored in the information storing unit.

### BACKGROUND OF THE INVENTION

1. Field of the Invention

The present invention relates to a technology for autonomously-establishing a test-access path between a test-access testing facility and a target transmitting apparatus including a target path to be tested by the test-access testing facility via a network and improving an efficiency of a remote test performed by the test-access testing facility.

2. Description of the Related Art

When a telecommunication company newly launches a network service, a plurality of transmitting apparatuses are newly installed across service areas. In this case, the telecommunication company needs to check a condition of a signal passing through the newly-installed transmitting apparatus, such as a rate and a quality of the signal. Moreover, the telecommunication company needs to check whether a network is kept at a predetermined level of service quality on a regular basis. Therefore, each of the transmitting apparatuses is configured to include a function of monitoring a signal quality, which is referred to as a test access function.

To check a signal flow of each of the transmitting apparatuses, if a testing facility (hereinafter, “a test-access testing facility”) is further installed or brought to each location where each of the transmitting apparatuses is installed, it disadvantageously costs to purchase the test-access testing facilities for all the transmitting apparatuses or to dispatch engineers to all the locations.

To avoid wasting such the expenses, the test-access testing facility is installed only in a central management center for managing the network, and configured to perform a signal quality test of each of the transmitting apparatuses remotely.

Consequently, when the test-access testing facility tests a signal of a remote transmitting apparatus, it is necessary to transmit the signal to the central management center via the network. Such the signal transmission is referred to as a remote test access. Incidentally, in a case of testing a signal of a transmitting apparatus which is directly connected to the test-access testing facility, such the signal transmission is referred to as a local test access.

FIG. 22 is a schematic diagram for explaining how a signal of the remote transmitting apparatus is relayed to the test-access testing facility. In this case, a signal of a target line X in a transmitting apparatus E, which is subjected to a test, is relayed to the test-access testing facility installed in the central management center via transmitting apparatuses D, C, B, and A, which are located between the transmitting apparatus E and the test-access testing facility.

According to a conventional technology for a remote test, a network topology for relaying the signal of the line X to the test-access testing facility is manually set by a network administrator, so that the network administrator is required to have deep knowledge of the network topology.

Incidentally, the network administrator can manually set the network topology by using a path management apparatus as disclosed in Japanese Patent Application Laid-open No. H11-122241. The path management apparatus is capable of automatically-creating an additional path between transmitting apparatuses to relay a signal.

Furthermore, the network administrator in the central management center is required to grasp the network topology and a band usage status precisely, and make manual settings for a signal transmitting path (relay path) to the target transmitting apparatus and a path connection between transmitting apparatuses on all transmitting apparatuses located on the relay path, including the target transmitting apparatus, every time the test-access testing facility implements a test.

Inconveniently, it takes a long time for the above settings, and also it may cause an increase of a maintenance fee because a setting error probably occurs due to the manual settings. Furthermore, the network administrator is also required to be proficient in issuing a command for setting a path connection, so that it costs to have the network administrator learn about the above setting. Moreover, even in a case of using the path management apparatus, the network administrator still needs to set the relay path to the target transmitting apparatus manually.

### SUMMARY OF THE INVENTION

It is an object of the present invention to at least partially solve the problems in the conventional technology.

A transmitting apparatus according to one aspect of the present invention includes an information storing unit that stores therein information on a connection status of transmitting apparatuses in a network and a usage status of a line between the transmitting apparatuses as access-path detecting information; and a path establishing unit that establishes a test communication path having a predetermined bandwidth for a test communication between a test-access testing facility and a target transmitting apparatus to be tested by the test-access testing facility via the network, based on the access-path detecting information stored in the information storing unit.

A method of testing a transmitting apparatus, according to another aspect of the present invention, includes storing information on a connection status of transmitting apparatuses in a network and a usage status of a line between the transmitting apparatuses as access-path detecting information; and establishing a test communication path having a predetermined bandwidth for a test communication between a test-access testing facility and a target transmitting apparatus to be tested by the test-access testing facility via the network, based on the access-path detecting information stored at the storing.

A computer-readable recording medium according to still another aspect of the present invention stores therein a computer program for testing a transmitting apparatus. The computer program causes a computer to execute storing information on a connection status of transmitting apparatuses in a network and a usage status of a line between the transmitting apparatuses as access-path detecting information; and establishing a test communication path having a predetermined bandwidth for a test communication between a test-access testing facility and a target transmitting apparatus to be tested by the test-access testing facility via the network, based on the access-path detecting information stored at the storing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an example of a network including transmitting apparatuses according to a first embodiment of the present invention;

FIG. 2 is a block diagram of one of the transmitting apparatuses shown in FIG. 1;

FIG. 3 is a list of types of test-access protocol data units (PDUs);

FIG. 4A is a list of items included in a remote test-access start command;

FIG. 4B is an example of a data structure of the remote test-access start command;

FIG. 5 is an example of a test-access routing table;

FIG. 6 is a schematic diagram for explaining a setting made by a test-access processing unit when a mode of a test access is SPLTEF;

FIG. 7 is a block diagram of a test-access PDU transmitting/receiving unit;

FIG. 8 is a block diagram of a test-access PDU transmitting/receiving unit in a case in which a test-access PDU is transmitted/received by using an Internet protocol (IP);

FIG. 9 is a block diagram of a test-access PDU transmitting/receiving unit in a case in which a test-access PDU is transmitted/received by using a connectionless network services (CLNS) protocol;

FIG. 10 is an example of a next-hop table;

FIG. 11 is a list of items to be input by an administrator for specifying a test-access path;

FIG. 12 is a sequence diagram in a case in which a remote test-access start command is successfully processed among the transmitting apparatuses;

FIG. 13 is a sequence diagram in a case in which the remote test-access start command fails to be processed among the transmitting apparatuses;

FIG. 14 is a sequence diagram in a case in which a test-access advance-confirmation command is successfully processed among the transmitting apparatuses;

FIG. 15 is a sequence diagram in a case in which the test-access advance-confirmation command fails to be processed among the transmitting apparatuses;

FIG. 16 is a sequence diagram in a case in which a test-access-list distribution notice is successfully processed among the transmitting apparatuses;

FIG. 17 is a sequence diagram in a case in which the test-access-list distribution notice fails to be processed among the transmitting apparatuses;

FIG. 18A is a flowchart of a process of receiving a connection/available-band information notice;

FIG. 18B is a continuation of the flowchart shown in FIG. 18A;

FIG. 19 is a flowchart of a process of receiving a remote test-access start command, which is performed by a relay transmitting apparatus;

FIG. 20 is a flowchart of a process of receiving a remote test-access start command, which is performed by a transmitting apparatus that receives a user's instruction direct;

FIG. 21 is block diagram of a computer that executes a transmitting-apparatus testing program according to a second embodiment of the present invention; and

FIG. 22 is a schematic diagram for explaining how a signal of a target line in a remote transmitting apparatus, which is subjected to a test, is relayed to a test-access testing facility.

### DETAILED DESCRIPTION OF THE PREFERRED EMBODIMENTS

Exemplary embodiments of the present invention are explained in detail below with reference to the accompanying drawings. According to the embodiments, the present invention is mainly applied to a synchronous optical network/synchronous digital hierarchy (SONET/SDH) transmitting apparatus, but the present invention is not limited to the embodiments.

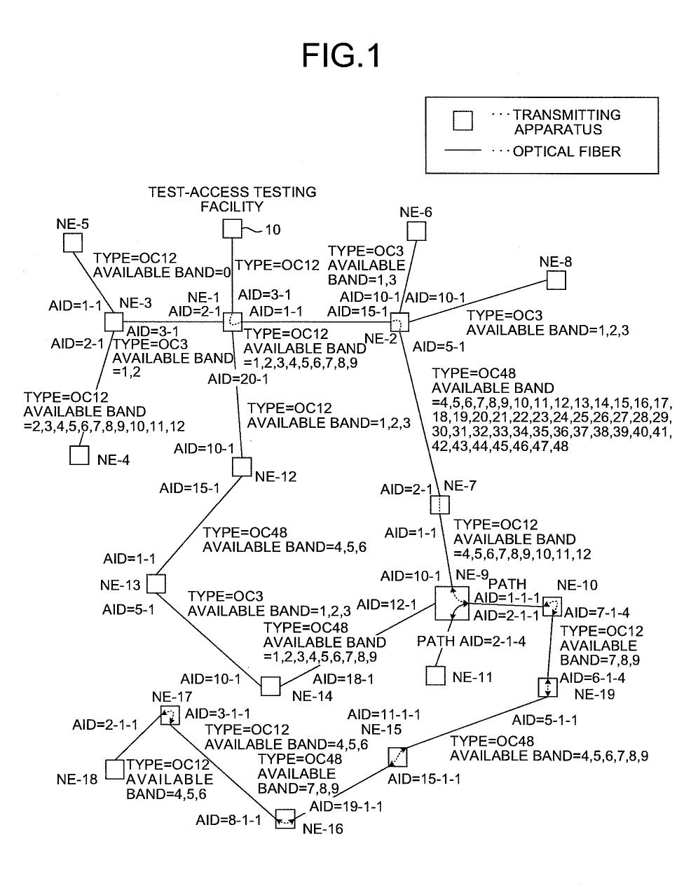

First, how a transmitting apparatus according to a first embodiment of the present invention establishes a test-access path autonomously is explained below. FIG. 1 is an example of a network including a plurality of the transmitting apparatuses according to the first embodiment. As shown in FIG. 1, the network includes the transmitting apparatuses, which are respectively denoted by NE-1 to NE-19 as a node identifier (ID), and a test-access testing facility 10. The test-access testing facility 10 is directly connected to the transmitting apparatus NE-1. The transmitting apparatuses NE-1 to NE-19 and the test-access testing facility 10 are connected by optical fibers. Types of the optical fibers are indicated by “TYPE=”, and a synchronous transport signal (STS) number that is not used is indicated by “AVAILABLE BAND=”. An access identifier (AID) denotes an ID for identifying a path, and is indicated by “AID=(slot number)-(port number)-(path number)”. Incidentally, in a case in which it is not necessary to specify a path in a port, the path number is omitted, i.e., the AID is indicated by “AID=(slot number)-(port number)”.

In the example shown in FIG. 1, it is indicated that the test-access testing facility 10 remotely tests a signal of a path (line) having “AID=1-1-1” in the transmitting apparatus NE-9.

Namely, it is necessary to establish a path between the transmitting apparatus NE-1 and the transmitting apparatus NE-9 to relay the signal to the test-access testing facility 10. Such the path to relay a signal of a target path to be tested is referred to as a test-access path.

When a transmitting apparatus receives a request for establishing a test-access path together with a specification of a target transmitting apparatus, which includes a target path to be tested by the test-access testing facility 10, from a user or an adjacent transmitting apparatus, the transmitting apparatus detects an optimum route to the target transmitting apparatus, and establishes a path connection based on the detected route, and then transfers the request to another adjacent transmitting apparatus located on the detected route.

Each of the transmitting apparatuses stores therein information on a connection status between transmitting apparatuses and a usage status of a line connecting between transmitting apparatuses, so that each of the transmitting apparatuses can autonomously detect the route based on the information. When the request is finally transferred to the target transmitting apparatus, the target transmitting apparatus makes settings required for the test. Then, the establishment of the test-access path is completed.

For example, it is assumed that the transmitting apparatus NE-2 receives a request for establishing a test-access path between the transmitting apparatus NE-1 and the transmitting apparatus NE-9 as a target transmitting apparatus. The transmitting apparatus NE-2 selects a route of “NE-2”-“NE-7”-“NE-9” as an optimum route, and connects a path having “AID=15-1” to a path having “AID=5-1”. Then, the transmitting apparatus NE-2 transfers the request to the transmitting apparatus NE-7 as an adjacent transmitting apparatus on the selected route.

In this manner, when receiving a request for establishing a test-access path together with a specification of a target transmitting apparatus from a user or an adjacent transmitting apparatus, the transmitting apparatus detects an optimum route to the target transmitting apparatus, and establishes a path connection based on the detected route, and then transfers the request to an adjacent transmitting apparatus on the detected route. Therefore, each of the transmitting apparatuses can autonomously establish the test-access path.

According to the first embodiment, each of the transmitting apparatus is configured to detect an optimum route to a target transmitting apparatus as a test-access path. Alternatively, a user can specify a test-access path to transmitting apparatuses on the test-access path.

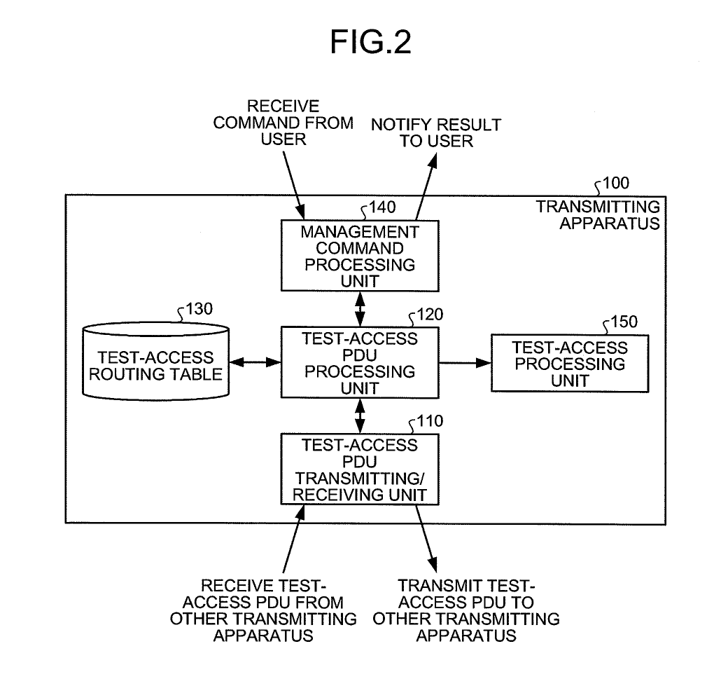

A configuration of the transmitting apparatus is explained in detail below. FIG. 2 is a block diagram of a transmitting apparatus 100 according to the first embodiment. The transmitting apparatus 100 includes a test-access protocol data unit (PDU) transmitting/receiving unit 110, a test-access PDU processing unit 120, a test-access routing table 130, a management-command processing unit 140, and a test-access processing unit 150.

When a test-access PDU is transmitted from other transmitting apparatus to the transmitting apparatus 100, the test-access PDU is received by the test-access PDU transmitting/receiving unit 110. The test-access PDU transmitting/receiving unit 110 outputs the received test-access PDU to the test-access PDU processing unit 120, and also transmits the test-access PDU to other transmitting apparatus in accordance with an instruction from the test-access PDU processing unit 120.

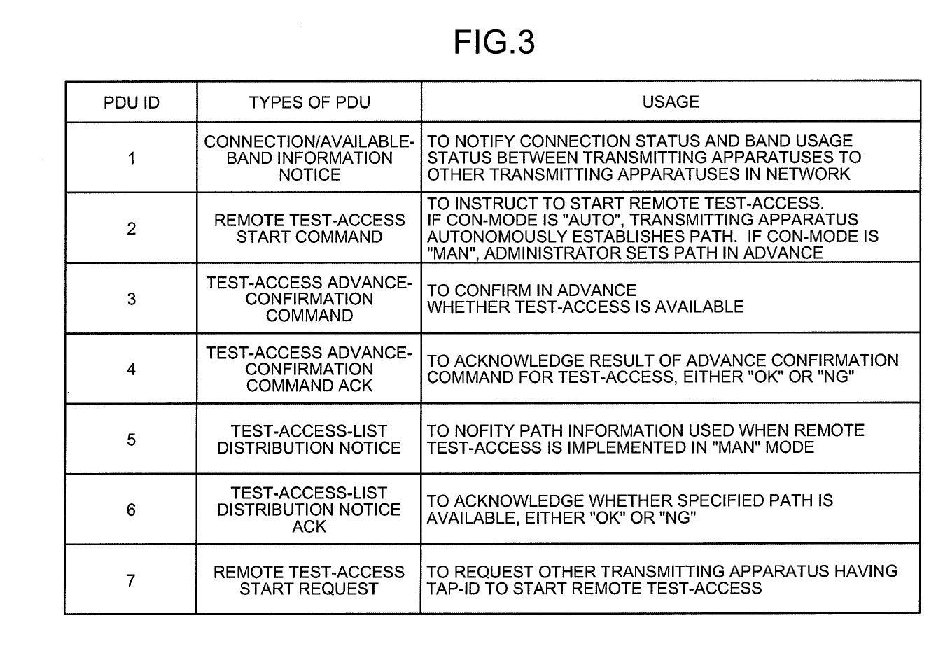

The test-access PDU is data for establishing a test-access path, and transmitted/received among the transmitting apparatuses. FIG. 3 is a list of types of test-access PDUs. As the types of test-access PDUs, a “connection/available-band information notice”, a “remote test-access start command”, a “test-access advance-confirmation command”, a “test-access advance-confirmation command acknowledgment (ACK)”, a “test-access-list distribution notice”, a “test-access-list distribution notice ACK”, and a “remote test-access start request” are cited in the list.

The “connection/available-band information notice” is used when necessary information for detecting an optimum route to a target transmitting apparatus, such as a connection status and a band usage status between transmitting apparatuses, is notified to other transmitting apparatus.

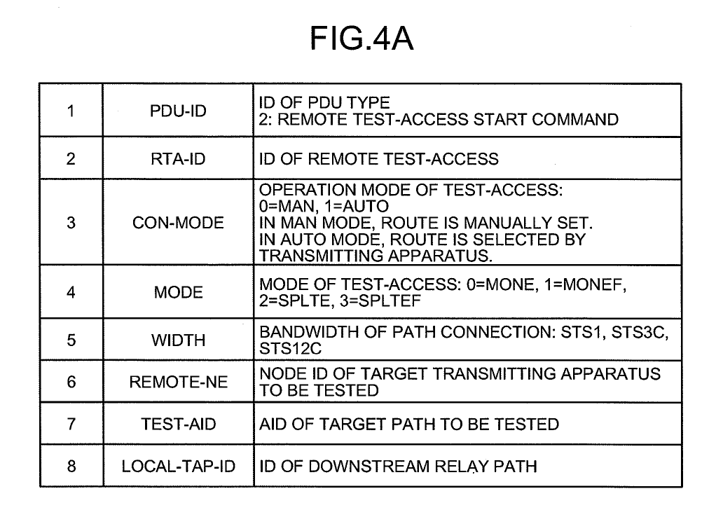

The “remote test-access start command” is used when each transmitting apparatus establishes a test-access path. FIG. 4A is a list of items included in a remote test-access start command.

As shown in FIG. 4A, the remote test-access start command includes “PDU-ID”, “RTA-ID”, “CON-MODE”, “MODE”, “WIDTH”, “REMOTE-NE”, “TEST-AID”, and “LOCAL-TAP-ID”. The “PDU-ID” indicates an ID of a type of a test-access PDU. The “RTA-ID” indicates an ID for identifying a remote test-access. The “CON-MODE” indicates an operation mode of a test-access. The “MODE” indicates a mode of a test-access. The “WIDTH” indicates a bandwidth of a test-access path. The “REMOTE-NE” indicates a node ID of a target transmitting apparatus. The “TEST-AID” indicates an AID of a target path to be tested. The “LOCAL-TAP-ID” indicates an AID of a downstream path used to relay a signal.

As types of the “CON-MODE”, there are “MAN” and “AUTO” modes. In the MAN mode, a test-access path is manually set by a user. In the “AUTO” mode, each of the transmitting apparatuses autonomously detects a test-access path.

As types of the “MODE”, there are “MONE”, “MONEF”, “SPLTE”, and “SPLTEF” modes. In the “MONE” mode, a signal reception in one side of a path connection is monitored. In the “MONEF” mode, a signal reception in both sides of a path connection is monitored. In the “SPLTE” mode, one side of a path connection is connected for a signal transmission/reception. In the “SPLTEF” mode, both sides of a path connection are connected for a signal transmission/reception.

The MODE is explained in detail below. For example, as shown in FIG. 1, the transmitting apparatus NE-11 is connected to the transmitting apparatus NE-18 via the transmitting apparatuses NE-9, NE-10, NE-19, NE-15, NE-16, and NE-17. At this time, it is assumed that a test-access path between the transmitting apparatus NE-1 and the transmitting apparatus NE-9 is already established.

When the path having “AID=1-1-1” in the transmitting apparatus NE-9, which is directed to the transmitting apparatus NE-10, is a target path to be tested, if it is in the “MONE” mode, the transmitting apparatus NE-9 transfers data on the path having “AID=1-1-1” to the transmitting apparatus NE-7. Therefore, the test-access testing facility 10 can monitor data on a path from the transmitting apparatus NE-18 to the transmitting apparatus NE-9. At this time, there is no effect on the path having “AID=1-1-1”.

Under the same condition above, if it is in the “MONEF” mode, the transmitting apparatus NE-9 transfers not only the data on the path having “AID=1-1-1” but also data on a path having “AID=2-1-4” in the transmitting apparatus NE-11, which is directed to the transmitting apparatus NE-9, to the transmitting apparatus NE-7. Therefore, the test-access testing facility 10 can monitor not only the data on a path from the transmitting apparatus NE-18 to the transmitting apparatus NE-9 but also data on a path from the transmitting apparatus NE-11 to the transmitting apparatus NE-9. At this time, there is no effect on the path having “AID=1-1-1”.

Under the same condition above, if it is in the “SPLTE” mode, the transmitting apparatus NE-9 cuts off a connection between the path having “AID=1-1-1” and the path having “AID=2-1-4”, and connects the path having “AID=1-1-1”to a path directed to the transmitting apparatus NE-7. Therefore, the test-access testing facility 10 can monitor the data on the path from the transmitting apparatus NE-18 to the transmitting apparatus NE-9, and also transfer test data to any transmitting apparatuses located on the path between the transmitting apparatus NE-9 and the transmitting apparatus NE-18.

Under the same condition above, if it is in the “SPLTEF” mode, the transmitting apparatus NE-9 cuts off a connection between the path having “AID=1-1-1” and the path having “AID=2-1-4”, and connects these paths to different paths directed to the transmitting apparatus NE-7, respectively. The path having “AID=1-1-1” is connected to a path specified in the LOCAL-TAP-ID. The path having “AID=2-1-4” is connected to a path having an available band next to that is for the path connected to the path having “AID=1-1-1”. Therefore, the test-access testing facility 10 can monitor data on both the path from the transmitting apparatus NE-18 to the transmitting apparatus NE-9 and the path from the transmitting apparatus NE-11 to the transmitting apparatus NE-9, and also transfer test data to any transmitting apparatuses located on the path between the transmitting apparatus NE-9 and the transmitting apparatus NE-18 and the path between the transmitting apparatus NE-11 and the transmitting apparatus NE-9.

FIG. 4B is an example of a data structure of a remote test-access start command. As shown in FIG. 4B, the remote test-access start command includes a test-access PDU header portion, including “PDU-ID” and the like, and a test-access PDU data portion, including “RTA-ID”, “CON-MODE”, and the like.

The “test-access advance-confirmation command” is used when it is confirmed in advance whether a test-access can be implemented. The “test-access advance-confirmation command ACK” is used when a result of the advance confirmation is acknowledged.

The “test-access-list distribution notice” is used, if the operation mode is “MAN” mode, to notify path information to transmitting apparatuses. The “test-access-list distribution notice ACK” is used to acknowledge whether a specified path is available is acknowledged.

The “remote test-access start request” is used, in a case in which a transmitting apparatus connected to the test-access testing facility 10 manages a TAP-ID, to request the transmitting apparatus to start establishing a test-access path. The TAP-ID is an ID used for uniquely-managing an ID of the transmitting apparatus connected to the test-access testing facility 10 together with an ID of a path connecting between the transmitting apparatus and the test-access testing facility 10 in the network.

The test-access PDU processing unit 120 processes a test-access PDU received from the test-access PDU transmitting/receiving unit 110. For example, when receiving a connection/available-band information notice, the test-access PDU processing unit 120 updates the test-access routing table 130 based on the received information on a connection status and a band usage status.

When receiving a remote test-access start command in which an operation mode of a test-access is specified in the “AUTO” mode, the test-access PDU processing unit 120 detects a test-access path based on the test-access routing table 130, and instructs the test-access processing unit 150 to establish a path connection based on the detected test-access path, and also instructs the test-access PDU transmitting/receiving unit 110 to transfer the remote test-access start command to an adjacent transmitting apparatus on the detected test-access path.

If the transmitting apparatus 100 is a target transmitting apparatus specified in the remote test-access start command, the test-access PDU processing unit 120 instructs the test-access processing unit 150 to make a setting for a test.

In this manner, when receiving a connection/available-band information notice, the test-access PDU processing unit 120 updates the test-access routing table 130 based on the received information on a connection status and a band usage status. Also, when receiving a remote test-access start command in which an operation mode of a test-access is specified in the “AUTO” mode, the test-access PDU processing unit 120 detects a test-access path based on the test-access routing table 130. Therefore, the transmitting apparatus 100 can autonomously establish a test-access path.

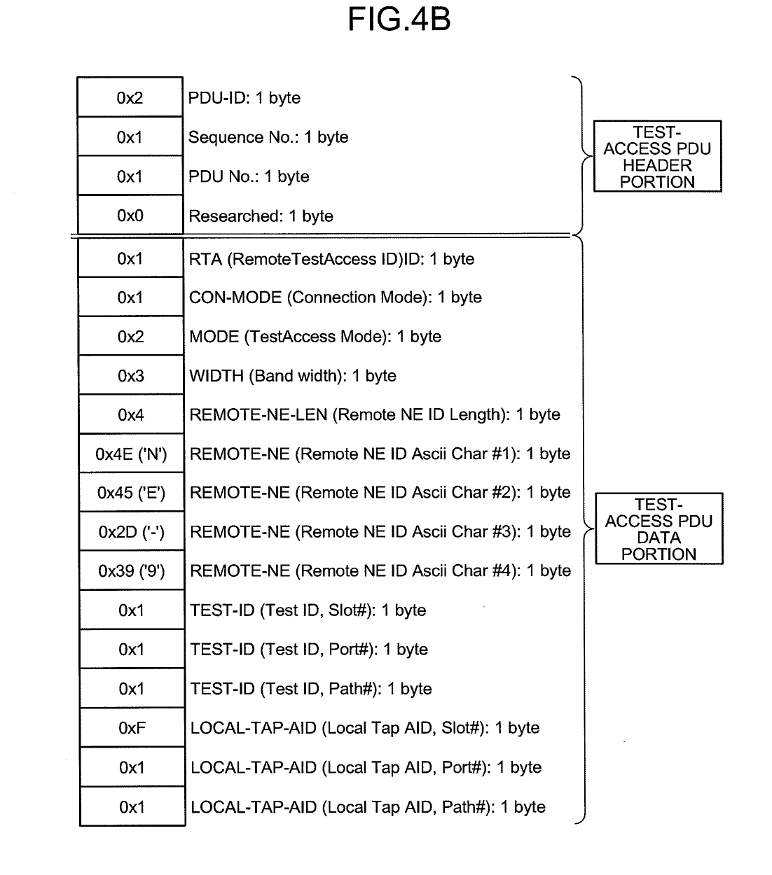

The test-access routing table 130 includes information on a connection status and a band usage status in the network. FIG. 5 is an example of the test-access routing table 130 stored in the transmitting apparatus 100 (in this case, the transmitting apparatus NE-1 shown in FIG. 1).

The test-access routing table 130 includes “source-node ID”, “adjacent-node ID”, “connection-path AID”, and “available band” by each of the transmitting apparatuses. The “source-node ID” indicates an ID of a transmitting apparatus that transmits a connection/available-band information notice. The “adjacent-node ID” indicates an ID of a transmitting apparatus adjacent to a transmitting apparatus having an ID indicated in a column of the source-node ID. The “connection-path AID” indicates an AID of a path connecting between transmitting apparatuses having IDs indicated in columns of the source-node ID and the adjacent-node ID. The “available band” indicates an STS level of an available band in a path having an AID indicated in a column of the connection-path AID.

The management-command processing unit 140 receives an instruction from a user (an administrator), and also notifies the user of a processing result of the received instruction. In a case in which the transmitting apparatus 100 is connected to the test-access testing facility 10, the management-command processing unit 140 receives an instruction for a test from the user.

The test-access processing unit 150 establishes a path connection based on an instruction from the test-access PDU processing unit 120. In a case in which the transmitting apparatus 100 is a target transmitting apparatus, the test-access processing unit 150 makes a setting for a mode of a test-access, which is specified in a remote test-access start command.

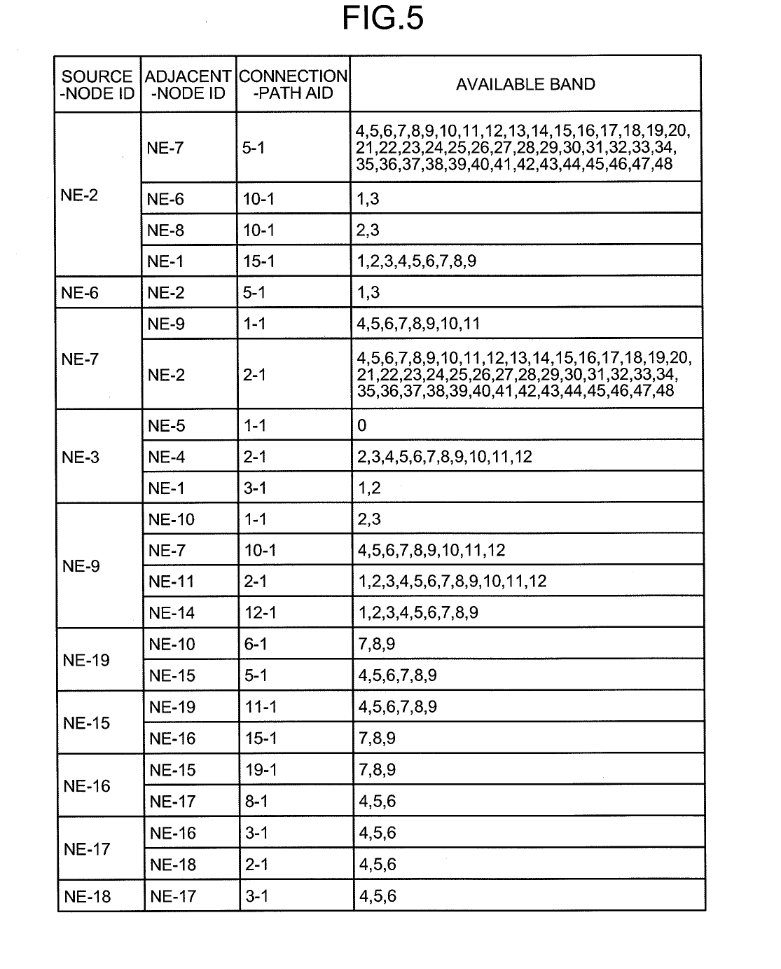

FIG. 6 is a schematic diagram for explaining a setting made by the test-access processing unit 150 when it is in the “SPLTEF” mode. If it is in the “SPLTEF” mode, the test-access processing unit 150 removes a cross connection of an operation setting, which is indicated by dotted lines in FIG. 6, and connects the target path having “AID=1-1-1” to the test-access testing facility 10 as an E port, and also connects a path, which was connected to the path having “AID=1-1-1”, to the test-access testing facility 10 as an F port.

Incidentally, in this case, the target transmitting apparatus is directly connected to the test-access testing facility 10, but if the target transmitting apparatus is connected to the test-access testing facility 10 via other transmitting apparatuses, a signal of a path connected to the target path is relayed to the test-access testing facility 10 via the other transmitting apparatuses.

In this manner, if the transmitting apparatus 100 is the target transmitting apparatus, the test-access processing unit 150 makes a setting for a mode of a test-access, which is specified in a remote test-access start command. As a result, the test-access testing facility 10 can test a remote path.

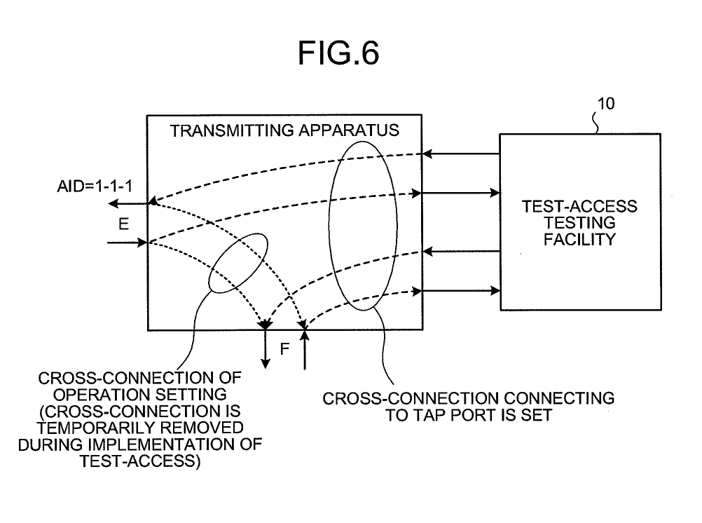

Subsequently, a configuration of the test-access PDU transmitting/receiving unit 110 is explained in detail below with reference to FIG. 7. The test-access PDU transmitting/receiving unit 110 includes a test-access PDU data partitioning/restructuring unit 111 and a J1 data transmitting/receiving unit 112.

The test-access PDU data partitioning/restructuring unit 111 partitions a test-access PDU into partitioned test-access PDUs, and transmits the partitioned test-access PDUs to the J1 data transmitting/receiving unit 112. Also, when receiving partitioned test-access PDUs from the J1 data transmitting/receiving unit 112, the test-access PDU data partitioning/restructuring unit 111 restructures the received test-access PDUs into a test-access PDU. Incidentally, partitioned test-access PDUs are respectively assigned a sequence number, which is stated in a row of “Sequence No.” shown in FIG. 4B, by the transmitting side of the test-access PDU data partitioning/restructuring unit 111, so that the receiving side of the test-access PDU data partitioning/restructuring unit 111 restructures partitioned test-access PDUs into a test-access PDU based on the sequence number.

The J1 data transmitting/receiving unit 112 transmits/receives a test-access PDU by using a J1 byte in a path overhead. Specifically, when receiving a test-access PDU, which is partitioned by the test-access PDU data partitioning/restructuring unit 111, the J1 data transmitting/receiving unit 112 inserts the received test-access PDU into a J1 byte. When the test-access PDU is to be output to the test-access PDU data partitioning/restructuring unit 111, the J1 data transmitting/receiving unit 112 takes the test-access PDU from the J1 byte, and then transmits the test-access PDU to the test-access PDU data partitioning/restructuring unit 111.

In this case, a test-access PDU is transmitted/received by using a J1 byte in a path overhead. Alternatively, a test-access PDU can be transmitted/received by using an Internet protocol (IP).

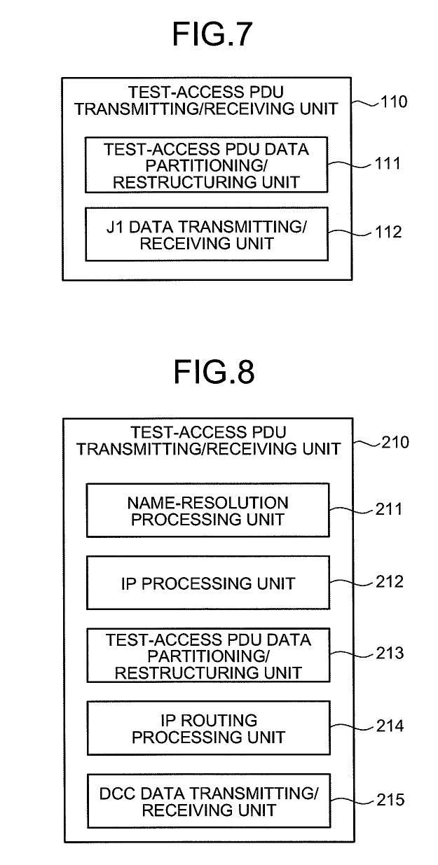

FIG. 8 is a block diagram of a test-access PDU transmitting/receiving unit 210 in a case in which a test-access PDU is transmitted/received by using an IP. The test-access PDU transmitting/receiving unit 210 includes a name-resolution processing unit 211, an IP processing unit 212, a test-access PDU data partitioning/restructuring unit 213, an IP routing processing unit 214, and a data communications channel (DCC) data transmitting/receiving unit 215.

The name-resolution processing unit 211 converts an ID of a transmitting apparatus into an IP address. The IP processing unit 212 processes a data transmission/reception by using an IP. The test-access PDU data partitioning/restructuring unit 213 partitions a test-access PDU into IP packets, and restructures a test-access PDU from IP packets.

The IP routing processing unit 214 determines a route of an IP packet. The DCC data transmitting/receiving unit 215 transmits/receives an IP packet by communicating via a DCC.

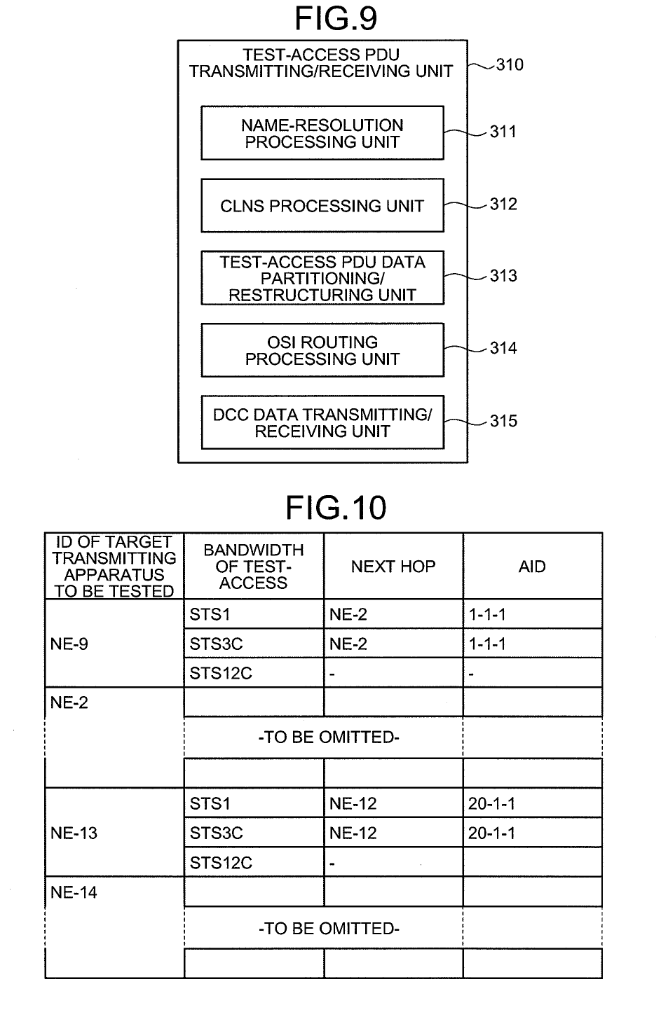

Instead of using the IP, a test-access PDU can be transmitted/received by using a connectionless network services (CLNS) protocol in open systems interconnection (OSI). FIG. 9 is a block diagram of a test-access PDU transmitting/receiving unit 310 in a case in which a test-access PDU is transmitted/received by using a CLNS protocol.

The test-access PDU transmitting/receiving unit 310 includes a name-resolution processing unit 311, a CLNS processing unit 312, a test-access PDU data partitioning/restructuring unit 313, an OSI routing processing unit 314, and a DCC data transmitting/receiving unit 315.

The name-resolution processing unit 311 converts an ID of a transmitting apparatus into a CLNS-protocol address. The CLNS processing unit 312 processes a data transmission/reception by using a CLNS protocol. The test-access PDU data partitioning/restructuring unit 313 partitions a test-access PDU into CLNS-protocol packets, and restructures a test-access PDU from CLNS protocol packets.

The OSI routing processing unit 314 determines a route of a CLNS-protocol packet. The DCC data transmitting/receiving unit 315 transmits/receives a CLNS-protocol packet by communicating via a DCC.

In a case in which the test-access testing facility 10 tests the path having “AID=1-1-1” in the transmitting apparatus NE-9 (see FIG. 1), processing procedures performed by each of the transmitting apparatuses are explained in detail below. When receiving a connection/available-band information notice, the transmitting apparatus updates information on a connection status and an available band, those stored in the test-access routing table 130. For example, it is assumed that the transmitting apparatus NE-1 includes the test-access routing table 130 as shown in FIG. 5.

Then, it is assumed that the administrator issues a remote test-access start command with following specifications to the transmitting apparatus NE-1.

TAP-ID=101

REMOTE-NE=NE-9

TEST-AID=1-1-1

MODE=SPLTE

At this time, the TAP-ID is managed to be uniquely assigned in the network (including the transmitting apparatuses). Therefore, when a TAP-ID is newly assigned to a combination of a transmitting apparatus and a connection path, the administrator needs to notify an ID of the transmitting apparatus and an AID of the connection path to the network before issuing a remote test-access start command. When the ID of the transmitting apparatus and the AID of the connection path are notified from the administrator, the network notifies an unused TAP-ID to the administrator. In this case, the ID of the transmitting apparatus is “NE-1”, and the AID of the connection path is “3-1-1”, and the unused TAP-ID is “101”.

The “REMOTE-NE” indicates an ID of a transmitting apparatus including a target path to be tested, and the “TEST-AID” indicates an AID of the target path, and the “MODE” indicates a mode of a test-access, i.e., a type of a connection between the target path and the test-access testing facility 10.

When receiving the above remote test-access start command, the transmitting apparatus NE-1 refers to the test-access routing table 130 shown in FIG. 5, and determines that there is an available band corresponding to the concatenated synchronous transport signal level 3 (STS3C) in the path having “AID=1-1-1” extending from the transmitting apparatus NE-1 to the transmitting apparatus NE-2, and in a path having “AID=10-1-4” extending from the transmitting apparatus NE-2 to the transmitting apparatus NE-7, and also in a path having “AID=1-1-4” extending from the transmitting apparatus NE-7 to the transmitting apparatus NE-9.

To transmit a signal from the test-access testing facility 10 to the transmitting apparatus NE-2, the transmitting apparatus NE-1 connects the path having “AID=3-1-1” to the path having “AID=1-1-1”. Namely, the transmitting apparatus NE-2 is a transmitting apparatus that receives the remote test-access start command next (hereinafter, referred to as a “next hop”).

There are two routing methods of determining a next hop. As a first routing method, an appropriate route is calculated in advance, and a next hop is determined based on the calculated route. As a second routing method, upon issuance of a remote test-access start command, a next hop is determined by referring to the test-access routing table 130.

The above second routing method is explained in detail below. It is assumed that upon issuance of a remote test-access start command, the transmitting apparatus 100 determines a next hop by referring to the test-access routing table 130. In this case, a path directing from the transmitting apparatus NE-1 to the transmitting apparatus NE-9 is to be established.

First, information on the transmitting apparatus NE-9, which includes a target path to be tested, is retrieved from the test-access routing table 130. Namely, out of transmitting apparatuses listed on a column of the adjacent-node ID in the test-access routing table 130, transmitting apparatuses which source-node ID is “NE-9” are checked in the order from the top. The transmitting apparatus NE-10, which is listed on the top of the column of the adjacent-node ID in the above condition, has available bands in the STS levels 2 and 3, which are an insufficient bandwidth for the STS3C. Therefore, it is determined that the transmitting apparatus NE-10 cannot be used. Next, an available band of the transmitting apparatus NE-7, which is listed on the second from the top of the column, is checked, and it is determined that a sufficient bandwidth for the STS3C can be obtained in the transmitting apparatus NE-7. Then, out of transmitting apparatuses listed on the column of the adjacent-node ID in the test-access routing table 130, transmitting apparatuses which source-node ID is “NE-7” are checked in the order from the top.

The transmitting apparatus NE-9, which is listed on the top of the column of the adjacent-node ID in the above condition, is located upstream of the detecting route, so that the transmitting apparatus NE-9 is excluded. The transmitting apparatus NE-2, which is listed on the second from the top of the column, is checked, and it is determined that a sufficient bandwidth for the STS3C can be obtained in the transmitting apparatus NE-2. Then, out of transmitting apparatuses listed on the column of the adjacent-node ID in the test-access routing table 130, transmitting apparatuses which source-node ID is “NE-2” are checked in the order from the top, excluding the transmitting apparatus NE-7 because the transmitting apparatus NE-7 is located upstream of the detecting route. An available band of the transmitting apparatus NE-6, which is listed on the top of the column excluding the transmitting apparatus NE-7, is checked, and it is determined that a sufficient bandwidth for the STS3C can be obtained in the transmitting apparatus NE-6. Then, out of transmitting apparatuses listed on the column of the adjacent-node ID in the test-access routing table 130, transmitting apparatuses which source-node ID is “NE-6” are checked in the order from the top. In this case, only the transmitting apparatus NE-2 is listed thereon, so that the transmitting apparatus NE-6 is excluded. Returning back to the column of adjacent-node ID in the test-access routing table 130, out of the transmitting apparatuses which source-node ID is “NE-2”, as for the transmitting apparatus NE-8, which is listed next to the transmitting apparatus NE-6, it is determined that a sufficient bandwidth for the STS3C cannot be obtained. Therefore, the transmitting apparatus NE-8 is excluded. As for the transmitting apparatus NE-1, which is listed next to the transmitting apparatus NE-8, it is determined that a sufficient bandwidth for the STS3C can be obtained.

Consequently, it is determined that a line connection for the STS3C can be established between each of the transmitting apparatuses “NE-1”-“NE-2”-“NE-7”-“NE-9”.

Incidentally, in a case of the first routing method, in the same manner as the above procedures, a route capable of creating paths which respectively have each of bandwidths for the “synchronous transport signal level 1 (STS1)”, “STS3C”, and “concatenated synchronous transport signal level 12 (STS12C)”, from the transmitting apparatus NE-9 is detected in advance, and a next hop with respect to each of the bandwidths is stored in a next-hop table. If there are a plurality of routes in which the same bandwidth is secured, a route having the smallest number of hops is to be selected.

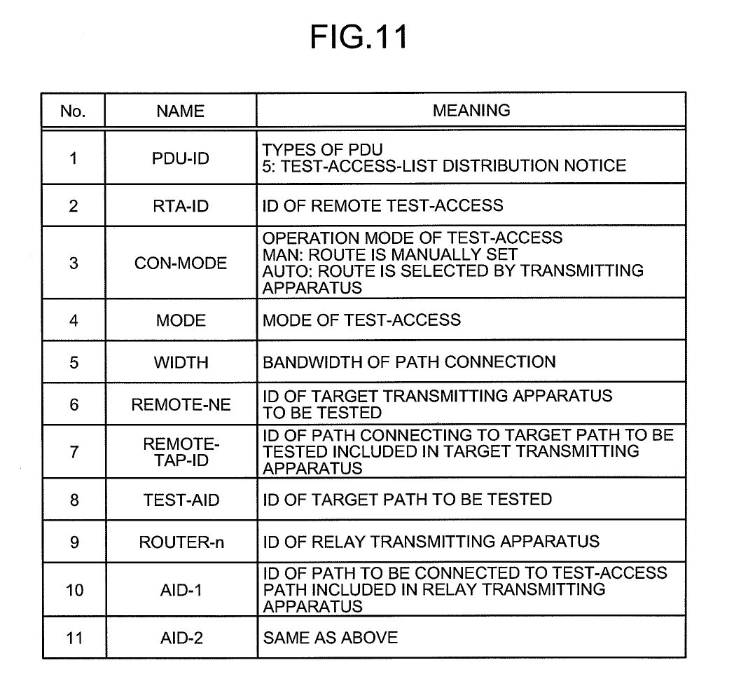

FIG. 10 is an example of the next-hop table. The next-hop table includes “test-access bandwidth”, “next hop”, and “AID” in associated manner by each transmitting apparatus.

One of search algorithms is applied to the example shown in FIG. 10. Alternatively, other algorithms, such as a shortest path first algorithm, can be used to search a shortest route. Then, a next hop is determined based on the searched shortest route and band information.

When the transmitting apparatus NE-2 is determined as a next hop, the transmitting apparatus NE-1 creates a remote test-access start command, including specifications for an AID of a target path to be tested, an ID of a transmitting apparatus including the target path, a bandwidth, an operation mode of a test-access, a mode of a test-access, and the like. Then, the transmitting apparatus NE-1 transmits an STS3C signal in which the created remote test-access start command is inserted into a J1 byte towards the path having “AID=1-1-1”.

When receiving the STS3C signal on a path having “AID=15-1-1”, the transmitting apparatus NE-2 retrieves a test-access PDU from the J1 byte, and determines that the test-access PDU is the remote test-access start command in which the path having “AID=1-1-1” in the transmitting apparatus NE-9 is specified as a target of a test-access in the SPLTE mode.

In the same manner as performed by the transmitting apparatus NE-1, the transmitting apparatus NE-2 determines a route to the transmitting apparatus NE-9 based on the test-access routing table 130. Then, the transmitting apparatus NE-2 transmits an STS3C signal in which the same test-access PDU as that is transmitted from the transmitting apparatus NE-1 is inserted into a J1 byte to a path having “AID=5-1-4”. The transmitting apparatus NE-2 connects the path having “AID=5-1-4” to the path having “AID=15-1-1”, as a relay path, with a bandwidth for the STS3C. Incidentally, it is in the SPLTE mode, so that the connection is made in both transmitting and receiving directions.

Then, the STS3C signal is detected, as a data reception, on the path having “AID=2-1-4” in the transmitting apparatus NE-7. The transmitting apparatus NE-7 retrieves a test-access PDU from the J1 byte, and determines that the test-access PDU is the remote test-access start command in which the path having “AID=1-1-1” in the transmitting apparatus NE-9 is specified as a target of the test-access in the SPLTE mode.

In the same manner as performed by the transmitting apparatus NE-1, the transmitting apparatus NE-7 determines a route to the transmitting apparatus NE-9 based on the test-access routing table 130. Then, the transmitting apparatus NE-2 transmits an STS3C signal in which the same test-access PDU as that is transmitted from the transmitting apparatus NE-1 is inserted into a J1 byte to the path having “AID=1-1-4”. The transmitting apparatus NE-7 connects the path having “AID=2-1-4” to the path having “AID=1-1-4”, as a relay path, with a bandwidth for the STS3C. Incidentally, it is in the SPLTE mode, so that the connection is made in both transmitting and receiving directions.

Then, the STS3C signal is detected, as a data reception, on the path having “AID=10-1-4” in the transmitting apparatus NE-9. The transmitting apparatus NE-9 retrieves a test-access PDU from the J1 byte, and determines that the test-access PDU is the remote test-access start command in which the path having “AID=1-1-1” in the transmitting apparatus NE-9 is specified as a target of the test-access in the SPLTE mode. The transmitting apparatus NE-9 makes a setting for the test-access on the target path having “AID=1-1-1”. In this case, a test-access destination is the path having “AID=10-1-4” where the J1 byte including the test-access PDU is received. Also, it is in the SPLTE mode, so that the transmitting apparatus NE-9 cuts off the connection between the path having “AID=1-1-1” and the path having “AID=2-1-4”, and connects the path having “AID=10-1-4” to the path having “AID=1-1-1” in both transmitting and receiving directions. In the event, the connection for the STS3C signal transmission/reception between the test-access testing facility 10 and the path having “AID=1-1-1”, as the target path to be tested, in the transmitting apparatus NE-9 is completed.

A method of transmitting/receiving a test-access PDU by communicating via a DCC, instead of using a J1 byte, is explained below. When the transmitting apparatus NE-1 determines the transmitting apparatus NE-2 as a next hop, the transmitting apparatus NE-1 creates a remote test-access start command, including specifications for an AID of a target path to be tested, an ID of a transmitting apparatus including the target path, a bandwidth, an operation mode of a test-access, a mode of a test-access, and the like, and transmits the created remote test-access start command to the transmitting apparatus NE-2.

When receiving the remote test-access start command from the transmitting apparatus NE-1, the transmitting apparatus NE-2 determines the transmitting apparatus NE-7 as a next hop based on the test-access routing table 130, and also determines the path having “AID=5-1-4” as a relay path. Then, the transmitting apparatus NE-2 connects the path having “AID=15-1-1” to the path having “AID=5-1-4”, and notifies the transmitting apparatus NE-7 of the remote test-access start command.

In this manner, the same result as the method of using a J1 byte can be obtained. Incidentally, to achieve the method of transmitting/receiving a test-access PDU by communicating via the DCC, it is necessary to create a new protocol. For example, a protocol is newly created in the fourth layer of the OSI protocol, and a new type of PDUs can be added in the newly-created protocol to define a new service access point.

In a case of using an IP-over-DCC protocol, a new port number is defined in a user datagram protocol (UDP), and a new type of PDUs for a service corresponding to the new port number can be added thereinto.

In either case of using an OSI protocol or an IP, the typical routing protocol methods, such as the target identifier address resolution protocol (TARP), the domain name system (DNS), the intermediate system to intermediate system (IS-IS), the routing information protocol (RIP), and the open shortest path first (OSPF), can be applied to obtain a network address or to determine a transmitting destination (a route destination on a network protocol) based on an ID of a transmitting apparatus indicated as a next hop.

According to the first embodiment, each of the transmitting apparatuses autonomously selects a path for relaying a signal from a target path to be tested. Alternatively, the administrator can set the path in advance. In this case, the administrator needs to have an apparatus for setting a test-access path to a target path to be tested in a target transmitting apparatus and also to grasp a network topology and a band usage status of each relay transmitting apparatus.

For example, in the network shown in FIG. 1, it is assumed that a route to the transmitting apparatus NE-9 via the transmitting apparatus NE-12 is selected as a remote test-access path, instead of a route to the transmitting apparatus NE-9 via the transmitting apparatus NE-2.

In this case, the administrator first creates a list as follows.

PDU-ID=3

RTA-ID=2

CON-MODE=MAN

MODE=SPLTE

WIDTH=STS3C

REMOTE-NE=NE-9, TEST-AID=1-1-1, REMOTE-TAP-ID=12-1-1

ROUTER-1=NE-12, AID-1=10-1-1, AID-2=15-1-4

ROUTER-2=NE-13, AID-1=1-1-4, AID-2=5-1-1

ROUTER-3=NE-14, AID-1=10-1-1, AID-2=18-1-1

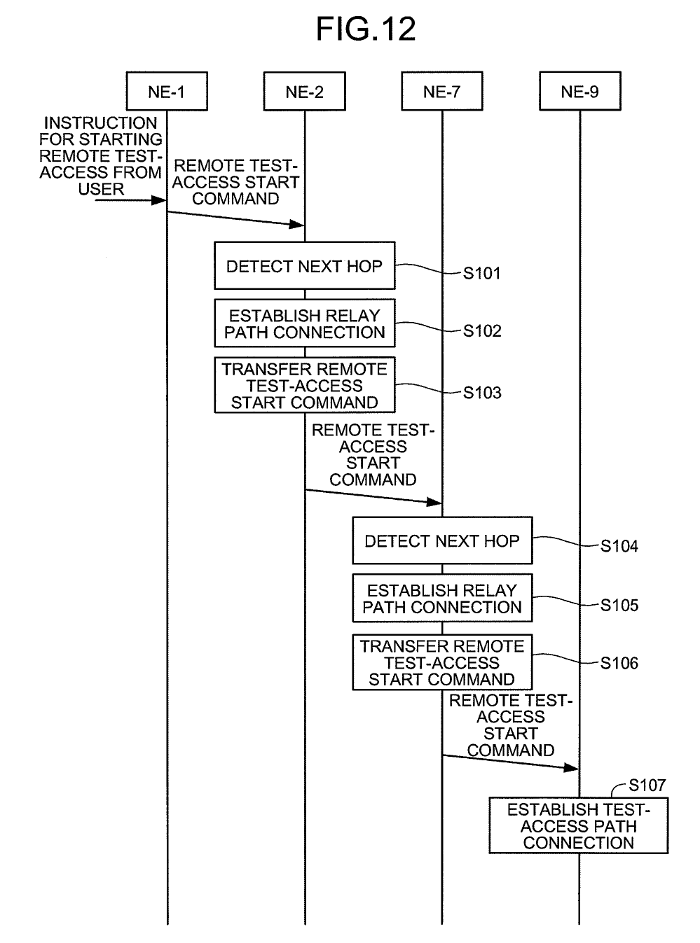

As for explanations of the above items, refer to FIG. 11.

The administrator issues the transmitting apparatus NE-1 a command to distribute the above list to transmitting apparatuses indicated in ROUTER-n in the above list. When receiving the command from the administrator, the transmitting apparatus NE-1 distribute the above list to the transmitting apparatuses indicated in the ROUTER-n. Each of the transmitting apparatuses indicated in the ROUTER-n respectively checks whether a path specified in the list is available for a test-access, and acknowledges either “OK” if a path is available for a test-access or “NG” if a path is not available for a test-access to the transmitting apparatus NE-1.

If the transmitting apparatus NE-1 receives “OK” from all the transmitting apparatuses, the transmitting apparatus NE-1 notifies the administrator that a test-access can be implemented. If the transmitting apparatus NE-1 receives “NG” from at least one of the transmitting apparatuses, the transmitting apparatus NE-1 notifies the administrator that a test-access cannot be implemented. In this manner, by receiving an acknowledgement either “OK” or “NG”, the administrator can avoid setting a route wrongly.

Then, the administrator inputs a remote test-access start command by specifying an RTA-ID to the transmitting apparatus NE-1. When receiving the remote test-access start command from the administrator, the transmitting apparatus NE-1 transmits the remote test-access start command together with the specification of the RTA-ID to the transmitting apparatuses NE-12, NE-13, NE-14, and NE-9, which are specified in the list by the administrator. When receiving the remote test-access start command together with the specification of the RTA-ID from the transmitting apparatus NE-1, the transmitting apparatuses NE-12, NE-13, NE-14, and NE-9 respectively establish a path connection as specified in the remote test-access start command. The transmitting apparatus NE-1 connects a path having “AID=20-1-1” (which is a relay path in the transmitting apparatus NE-12) to the path having “AID=3-1-1” (which is connected to the test-access testing facility 10). As a result, a signal for a test-access can be transmitted between the test-access testing facility 10 and the target path having “AID=1-1-1” in the transmitting apparatus NE-9.

Incidentally, the transmitting apparatus NE-1 can transmit the remote test-access start command to the transmitting apparatus NE-12 only. In this case, the transmitting apparatus NE-12 transfers the remote test-access start command to the transmitting apparatus NE-13 in accordance with the list. In the same manner as the transmitting apparatus NE-12, the transmitting apparatuses NE-13 and NE-14 also transfer the remote test-access start command to the transmitting apparatus in accordance with the list. Then, the remote test-access start command is finally transferred to the transmitting apparatus NE-9. Consequently, processing loads can be dispersed by each of the transmitting apparatuses.

The list or remote test-access start command can be distributed or transferred by adding a type of PDUs, for example, PDU-ID=5 for a test-access-list distribution notice and PDU-ID=6 for a test-access-list distribution notice ACK, into a CLNS protocol or an IP.

According to the first embodiment, the administrator issues a remote test-access start command to a transmitting apparatus with a specified TAP-ID (i.e., a transmitting apparatus directly-connected to the test-access testing facility 10), but not limited to the transmitting apparatus with the specified TAP-ID. The administrator can issue a remote test-access start command to any transmitting apparatus. In this case, a transmitting apparatus that receives the remote test-access start command from the administrator requests the transmitting apparatus with the specified TAP-ID to start processing. At this time, a “remote test-access start request” is used (see FIG. 3).

As in the case of the remote test-access start command in which the TAP-ID is specified, a new ID is preferably assigned to a combination of an AID of a target path to be tested and an ID of a transmitting apparatus including the target path. Therefore, for example, the administrator has the transmitting apparatuses store therein a RTA-ID for a test-access as follows.

RTA-ID=1:

CON-MODE=AUTO

MODE=SPLTE

WIDTH=STS3C

REMOTE-NE=NE-9, TEST-AID=1-1-1

In the process of controlling a test-access, the RTA-ID is used so that subsequent procedures for a remote test-access start command can be simplified.

In a case of issuing a test-access-list distribution notice, it is possible to confirm in advance a status of each relay transmitting apparatus located on the test-access path. However, in a case in which each of the transmitting apparatuses in the network autonomously selects a route towards a target path to be tested, there is a possibility that a relay transmitting apparatus cannot establish a test-access path for what ever reason. In this case, it is difficult to determine that either a signal of the target path is cut off, or the relay transmitting apparatus cannot establish a test-access path. To avoid such the situation, the relay transmitting apparatus can confirm whether it is in a test-access implementable status in advance, i.e., before executing a test-access start command.

For example, it is possible to newly add a type of PDUs for the advance confirmation, such as PDU-ID=3 for a test-access advance-confirmation command and PDU-ID=4 for a test-access advance-confirmation command ACK. When receiving the test-access PDU from the transmitting apparatus NE-1, each of relay transmitting apparatuses and a target transmitting apparatus having a target path to be tested determines whether a test-access can be implemented, and responds a result of the determination to the transmitting apparatus NE-1. Then, when receiving the result from the each of the relay transmitting apparatuses and the target transmitting apparatus, the transmitting apparatus NE-1 notifies the result to the administrator. Therefore, it is possible to determine that either the test-access PDU cannot be relayed, or a signal of the target path has a problem.

When the test-access testing facility 10 monitors a signal of the path having “AID=1-1-1” in the transmitting apparatus NE-9, as the target path to be tested, if it is determined that the signal has a problem in its quality, it is necessary to check which transmitting apparatus causes a degradation of the signal quality. Therefore, each signal quality from each path in each transmitting apparatus can be monitored as following procedures.

First, the administrator issues a command as follows.

TAP-ID=101

CON-MODE=STEP

MODE=MONE

WIDTH=STS3C

REMOTE-NE=NE-9, TEST-AID=1-1-1

STEP=4

When receiving the above command from the administrator, a path having “AID=7-1-4” in the transmitting apparatus NE-10, a path having “AID=5-1-1” in the transmitting apparatus NE-19, the path having “AID=15-1-1” in the transmitting apparatus NE-15, and a path having “AID=8-1-1” in the transmitting apparatus NE-16 are respectively connected to the path having “AID=3-1-1”, a path having “AID=3-1-4”, a path having “AID=3-1-7”, and a path having “AID=3-1-10” in the transmitting apparatus NE-1. In this case, it is in the MONE mode, so that a signal is monitored with keeping the connection on.

At this time, the administrator needs to define TAP-IDs as follows.

| | | |
|---|---|---|
| NE-ID = NE-1 | AID = 3-1-1 | :TAP-ID = 101 |
| NE-ID = NE-1 | AID = 3-1-4 | :TAP-ID = 102 |
| NE-ID = NE-1 | AID = 3-1-7 | :TAP-ID = 103 |
| NE-ID = NE-1 | AID = 3-1-10 | :TAP-ID = 104 |

With the above command, a quality of a signal transmitted to the path having “AID=1-1-1” in the transmitting apparatus NE-9 can be monitored. Therefore, it is possible to reduce a management cost of the administrator.

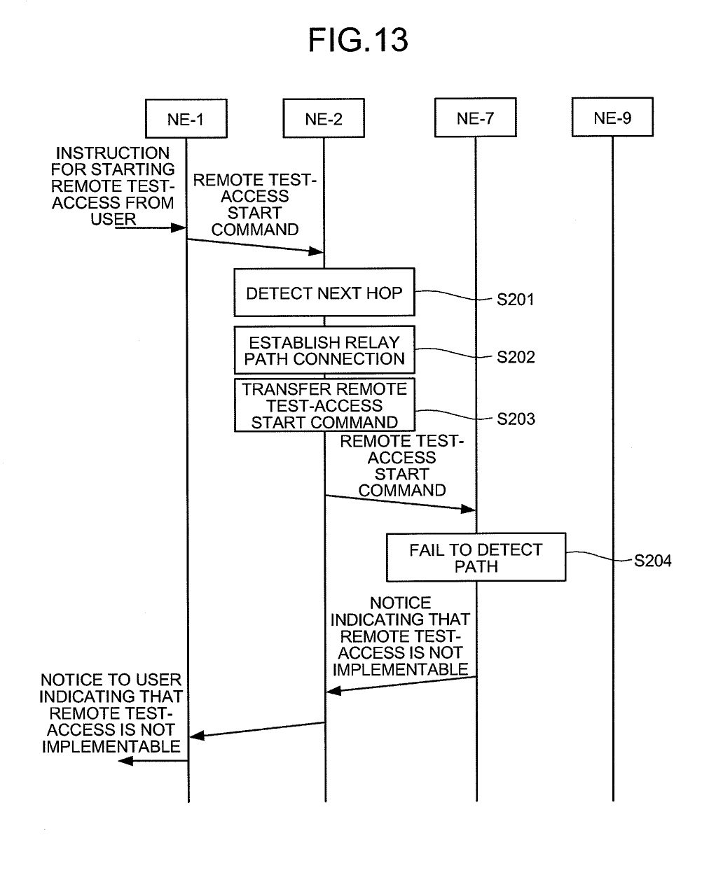

Subsequently, how a test-access PDU is processed among transmitting apparatuses is explained in detail below with reference to FIGS. 12 to 17. FIG. 12 is a sequence diagram in a case in which a remote test-access start command is successfully processed among the transmitting apparatuses.

When the transmitting apparatus NE-1 receives an instruction for starting a remote test-access from a user, the transmitting apparatus NE-1 connects a path having “AID=3-1-1” to the path having “AID=1-1-1”, and the test-access PDU processing unit 120 in the transmitting apparatus NE-1 creates a remote test-access start command, and the test-access PDU transmitting/receiving unit 110 in the transmitting apparatus NE-1 transmits the created remote test-access start command to the transmitting apparatus NE-2.

When receiving the remote test-access start command from the test-access PDU transmitting/receiving unit 110 in the transmitting apparatus NE-1, in the transmitting apparatus NE-2, the test-access PDU processing unit 120 detects a next hop based on the test-access routing table 130 (step S101), and the test-access processing unit 150 establishes a connection for a relay path (step S102), and then the test-access PDU transmitting/receiving unit 110 transfers the remote test-access start command to the transmitting apparatus NE-7 in accordance with an instruction from the test-access PDU processing unit 120 (step S103).

In the same manner as the above sequence, when receiving the remote test-access start command from the test-access PDU transmitting/receiving unit 110 in the transmitting apparatus NE-2, in the transmitting apparatus NE-7, the test-access PDU processing unit 120 detects a next hop based on the test-access routing table 130 (step S104), and the test-access processing unit 150 establishes a connection for a relay path (step S105), and then the test-access PDU transmitting/receiving unit 110 transfers the remote test-access start command to the transmitting apparatus NE-9 in accordance with an instruction from the test-access PDU processing unit 120 (step S106).

When receiving the remote test-access start command from the test-access PDU transmitting/receiving unit 110 in the transmitting apparatus NE-7, the test-access processing unit 150 in the transmitting apparatus NE-9, as the target transmitting apparatus, establishes a connection for a test-access path in accordance with the mode of the test-access (step S107).

In this manner, when each of the transmitting apparatuses receives a remote test-access start command, the test-access PDU processing unit 120 detects a next hop based on the test-access routing table 130, and the test-access processing unit 150 establishes a connection for a relay path, and then the test-access PDU transmitting/receiving unit 110 transfers the remote test-access start command to the next hop in accordance with an instruction from the test-access PDU processing unit 120. Therefore, a remote test-access path can be autonomously established.

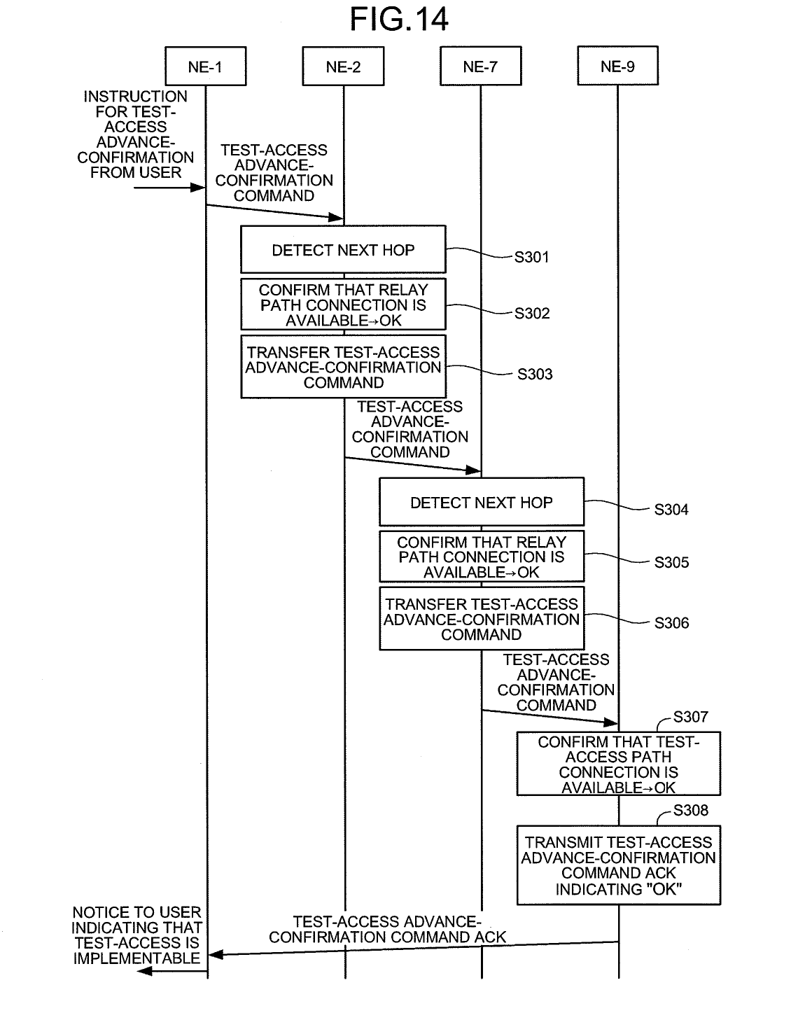

FIG. 13 is a sequence diagram in a case in which a remote test-access start command fails to be processed among the transmitting apparatuses. When the transmitting apparatus NE-1 receives an instruction for starting a remote test-access from a user, the transmitting apparatus NE-1 connects the path having “AID=3-1-1” to the path having “AID=1-1-1”, and the test-access PDU processing unit 120 in the transmitting apparatus NE-1 creates a remote test-access start command, and the test-access PDU transmitting/receiving unit 110 in the transmitting apparatus NE-1 transmits the created remote test-access start command to the transmitting apparatus NE-2.

When receiving the remote test-access start command from the test-access PDU transmitting/receiving unit 110 in the transmitting apparatus NE-1, in the transmitting apparatus NE-2, the test-access PDU processing unit 120 detects a next hop based on the test-access routing table 130 (step S201), and the test-access processing unit 150 establishes a connection for a relay path (step S202), and then the test-access PDU transmitting/receiving unit 110 transfers the remote test-access start command to the transmitting apparatus NE-7 in accordance with an instruction from the test-access PDU processing unit 120 (step S203).

In the same manner as the above sequence, when receiving the remote test-access start command from the test-access PDU transmitting/receiving unit 110 in the transmitting apparatus NE-2, the test-access PDU processing unit 120 in the transmitting apparatus NE-7 detects a next hop based on the test-access routing table 130, but fails to detect the next hop (step S204).

The test-access PDU transmitting/receiving unit 110 in the transmitting apparatus NE-7 transmits a notice indicating that the remote test-access is not implementable to the transmitting apparatus NE-2 in accordance with an instruction from the test-access PDU processing unit 120. In the same manner as in the transmitting apparatus NE-7, the test-access PDU transmitting/receiving unit 110 in the transmitting apparatus NE-2 transmits the notice indicating that the remote test-access is not implementable to the transmitting apparatus NE-1 in accordance with an instruction from the test-access PDU processing unit 120. When receiving the notice from the test-access PDU transmitting/receiving unit 110 in the transmitting apparatus NE-2, the transmitting apparatus NE-1 notifies the user that the remote test-access is not implementable.

In this manner, if the transmitting apparatus cannot detect a test-access path, the transmitting apparatus returns a notice indicating that the remote test-access is not implementable to the user. Therefore, the administrator (the user) can easily find out that either there is a problem to establish a test-access path, or a target path to be tested has a problem.

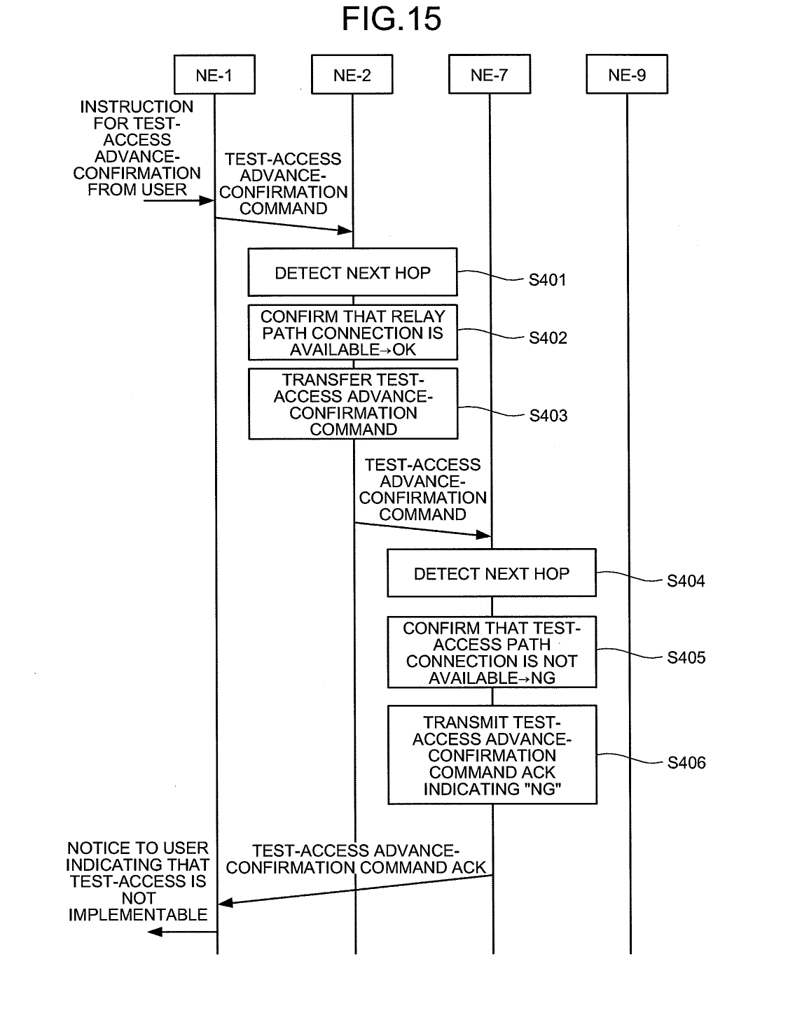

FIG. 14 is a sequence diagram in a case in which a test-access advance-confirmation command is successfully processed among the transmitting apparatuses. When receiving an instruction for confirming a test-access in advance from a user, the test-access PDU processing unit 120 in the transmitting apparatus NE-1 creates a test-access advance-confirmation command, and the test-access PDU transmitting/receiving unit 110 in the transmitting apparatus NE-1 transmits the created remote test-access start command to the transmitting apparatus NE-2.

When receiving the test-access advance-confirmation command from the test-access PDU transmitting/receiving unit 110 in the transmitting apparatus NE-1, in the transmitting apparatus NE-2, the test-access PDU processing unit 120 detects a next hop based on the test-access routing table 130 (step S301), and confirms that a relay path connection is available (step S302). Then, the test-access PDU transmitting/receiving unit 110 transfers the test-access advance-confirmation command to the transmitting apparatus NE-7 in accordance with an instruction from the test-access PDU processing unit 120 (step S303).

In the same manner as in the transmitting apparatus NE-2, when receiving the test-access advance-confirmation command from the test-access PDU transmitting/receiving unit 110 in the transmitting apparatus NE-2, in the transmitting apparatus NE-7, the test-access PDU processing unit 120 detects a next hop based on the test-access routing table 130 (step S304), and confirms that a relay path connection is available (step S305). Then, the test-access PDU transmitting/receiving unit 110 transfers the test-access advance-confirmation command to the transmitting apparatus NE-9 in accordance with an instruction from the test-access PDU processing unit 120 (step S306).

When receiving the test-access advance-confirmation command from the test-access PDU transmitting/receiving unit 110 in the transmitting apparatus NE-7, the test-access processing unit 150 in the transmitting apparatus NE-9, as the target transmitting apparatus, confirms that a connection for a test-access path is available (step S307), and transmits a test-access advance-confirmation command ACK indicating “OK”, i.e., the test-access advance-confirmation is successful to the transmitting apparatus NE-1 (step S308).

In this manner, when each of the transmitting apparatuses receives a test-access advance-confirmation command, the test-access PDU processing unit 120 detects a next hop based on the test-access routing table 130, and the test-access processing unit 150 confirms a relay path connection, and then the test-access PDU transmitting/receiving unit 110 transfers the test-access advance-confirmation command to the next hop in accordance with an instruction from the test-access PDU processing unit 120. As a result, it is possible to confirm in advance whether a remote test-access is implementable.

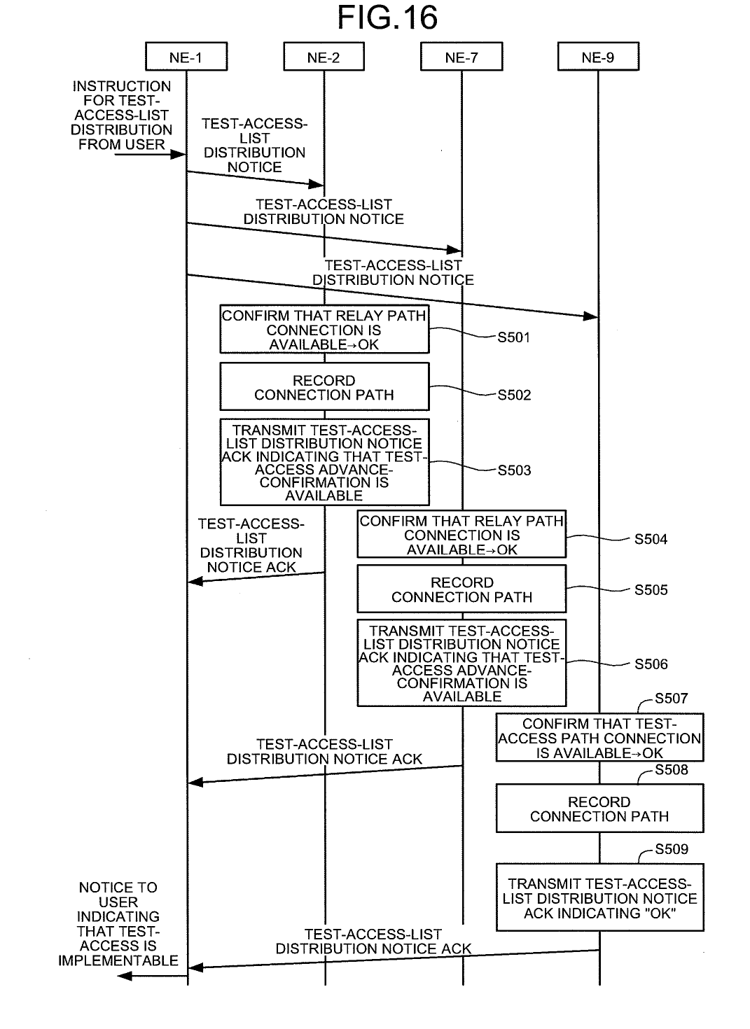

FIG. 15 is a sequence diagram in a case in which a test-access advance-confirmation command fails to be processed among the transmitting apparatuses. When receiving an instruction for confirming a test-access in advance from a user, the test-access PDU processing unit 120 in the transmitting apparatus NE-1 creates a test-access advance-confirmation command, and the test-access PDU transmitting/receiving unit 110 in the transmitting apparatus NE-1 transmits the created remote test-access start command to the transmitting apparatus NE-2.

When receiving the test-access advance-confirmation command from the test-access PDU transmitting/receiving unit 110 in the transmitting apparatus NE-1, in the transmitting apparatus NE-2, the test-access PDU processing unit 120 detects a next hop based on the test-access routing table 130 (step S401), and confirms that a relay path connection is available (step S402). Then, the test-access PDU transmitting/receiving unit 110 transfers the test-access advance-confirmation command to the transmitting apparatus NE-7 in accordance with an instruction from the test-access PDU processing unit 120 (step S403).

In the same manner as in the transmitting apparatus NE-2,when receiving the test-access advance-confirmation command from the test-access PDU transmitting/receiving unit 110 in the transmitting apparatus NE-2,the test-access PDU processing unit 120 in the transmitting apparatus NE-7 detects a next hop based on the test-access routing table 130 (step S404), but fails to detect the next hop, i.e., confirms that a relay path connection is not available (step S405). Therefore, the test-access PDU processing unit 120 transmits a test-access advance-confirmation command ACK indicating “NG”, i.e., the test-access advance-confirmation is failed to the transmitting apparatus NE-1 (step S406).

In this manner, in a case of “NG” for the test-access advance-confirmation, the test-access advance-confirmation command ACK indicating “NG” is transmitted from the transmitting apparatus that confirms that a relay path connection is not available. Therefore, the administrator (the user) can easily find out that either there is a problem to establish a test-access path, or a target path to be tested has a problem.

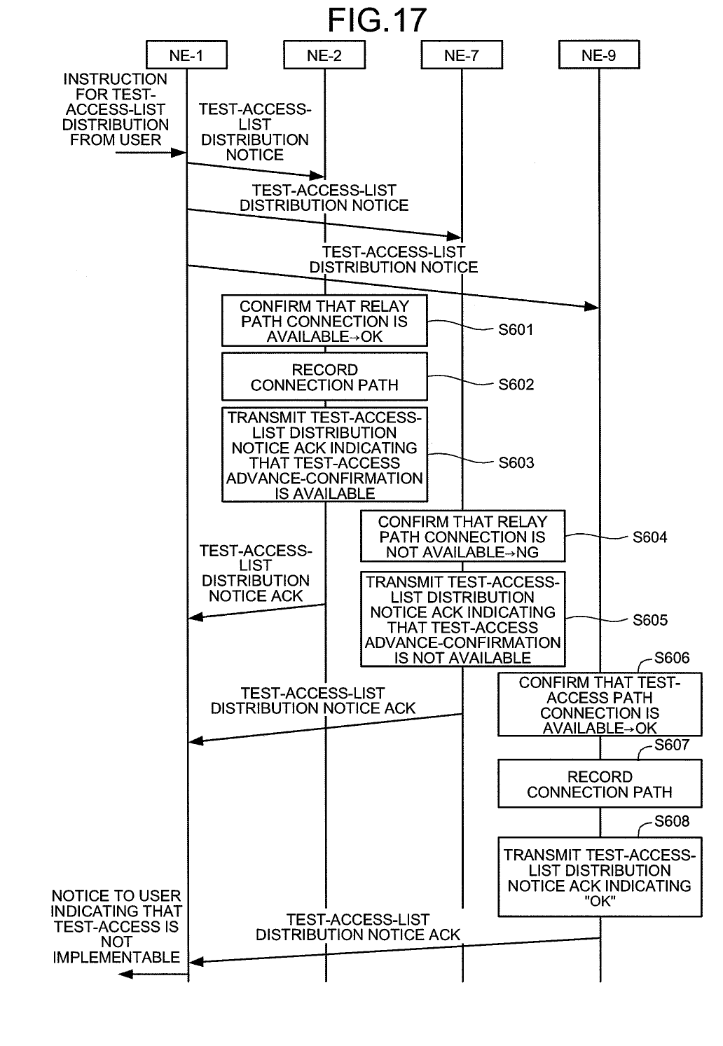

FIG. 16 is a sequence diagram in a case in which a test-access-list distribution notice is successfully processed among the transmitting apparatuses. When receiving an instruction for distributing a test-access list from a user, the test-access PDU processing unit 120 in the transmitting apparatus NE-1 creates a test-access-list distribution notice, and the test-access PDU transmitting/receiving unit 110 in the transmitting apparatus NE-1 transmits the created test-access-list distribution notice to the transmitting apparatuses NE-2, NE-7, and NE-9.

When receiving the test-access-list distribution notice from the test-access PDU transmitting/receiving unit 110 in the transmitting apparatus NE-1, in the transmitting apparatus NE-2, the test-access PDU processing unit 120 confirms that a relay path connection is available (step S501), and records a connection path (step S502), and then transmits a test-access-list distribution notice ACK indicating “OK”, i.e., the test-access advance-confirmation is successful to the transmitting apparatus NE-1 (step S503).

In the transmitting apparatus NE-7, when receiving the test-access-list distribution notice from the test-access PDU transmitting/receiving unit 110 in the transmitting apparatus NE-1, in the same manner as in the transmitting apparatus NE-2, the test-access PDU processing unit 120 confirms that a relay path connection is available (step S504), and records a connection path (step S505), and then transmits a test-access-list distribution notice ACK indicating “OK” to the transmitting apparatus NE-1 (step S506).

In the transmitting apparatus NE-9, when receiving the test-access-list distribution notice from the test-access PDU transmitting/receiving unit 110 in the transmitting apparatus NE-1, in the same manner as in the transmitting apparatus NE-2 or NE-7, the test-access PDU processing unit 120 confirms that a connection for a test-access path is available (step S507), and records a connection path (step S508), and then transmits a test-access-list distribution notice ACK indicating “OK” to the transmitting apparatus NE-1 (step S509).

When all the test-access-list distribution notice ACK transmitted to the transmitting apparatus NE-1 indicate “OK”, the transmitting apparatus NE-1 notifies the user that a test-access is implementable.

In this manner, when each of the transmitting apparatuses receives a test-access-list distribution notice, it is confirmed that a connection for a test-access path is available, and its connection path is recorded, and then a test-access-list distribution notice ACK indicating “OK”, i.e., the test-access advance-confirmation is successful is transmitted. Therefore, the administrator (the user) can confirm whether a remote test-access is implementable in advance.

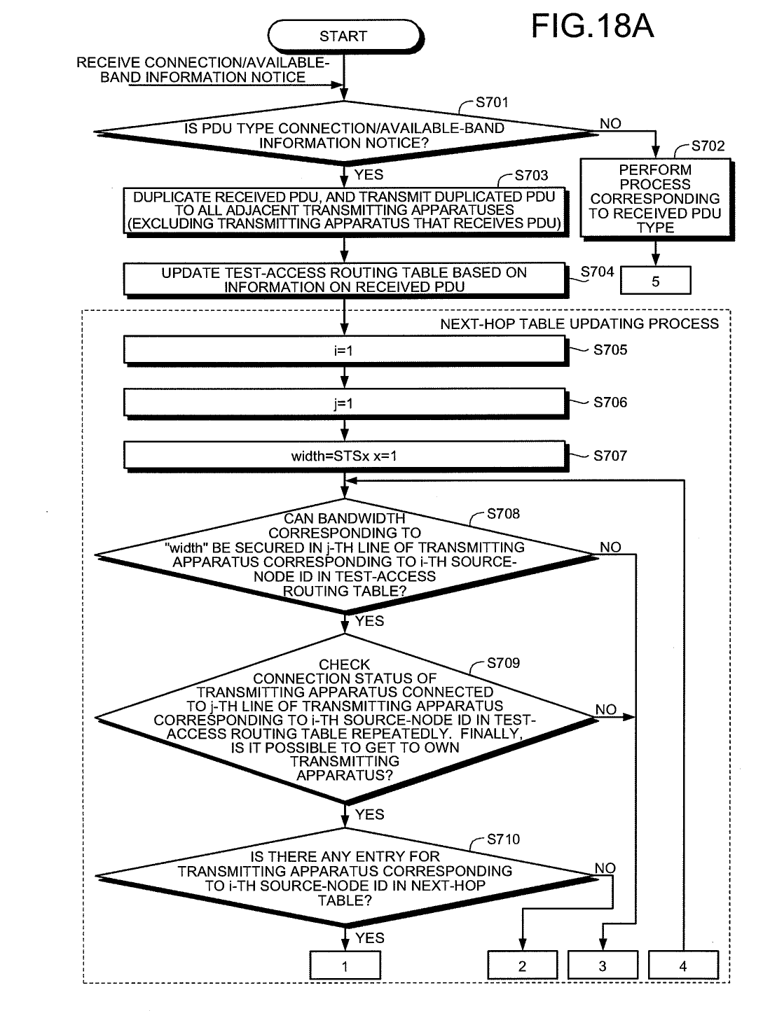

FIG. 17 is a sequence diagram in a case in which a test-access-list distribution notice fails to be processed among the transmitting apparatuses. When receiving an instruction for distributing a test-access list from a user, the test-access PDU processing unit 120 in the transmitting apparatus NE-1 creates a test-access-list distribution notice, and the test-access PDU transmitting/receiving unit 110 in the transmitting apparatus NE-1 transmits the created test-access-list distribution notice to the transmitting apparatuses NE-2, NE-7, and NE-9.

In the transmitting apparatus NE-2, when receiving the test-access-list distribution notice from the test-access PDU transmitting/receiving unit 110 in the transmitting apparatus NE-1, the test-access PDU processing unit 120 confirms that a relay path connection is available (step S601), and records its connection path (step S602), and then transmits a test-access-list distribution notice ACK indicating “OK” to the transmitting apparatus NE-1 (step S603).

In the transmitting apparatus NE-7, when receiving the test-access-list distribution notice from the test-access PDU transmitting/receiving unit 110 in the transmitting apparatus NE-1, the test-access PDU processing unit 120 confirms that a relay path connection is not available (step S604), and transmits a test-access-list distribution notice ACK indicating “NG”, i.e., a path connection for a test-access is not available to the transmitting apparatus NE-1 (step S605).

In the transmitting apparatus NE-9, when receiving the test-access-list distribution notice from the test-access PDU transmitting/receiving unit 110 in the transmitting apparatus NE-1, the test-access PDU processing unit 120 confirms that a connection for a test-access path is available (step S606), and records its connection path (step S607), and then transmits a test-access-list distribution notice ACK indicating “OK” to the transmitting apparatus NE-1 (step S608).

The transmitting apparatus NE-1 receives the test-access-list distribution notice ACK indicating “NG” from the transmitting apparatus NE-7, so that the transmitting apparatus NE-1 notifies the user that a test-access is not implementable.

In this manner, when each of the transmitting apparatuses receives a test-access-list distribution notice, it is confirmed whether a connection for a test-access path is available. If a connection for a test-access path is not available, a test-access-list distribution notice ACK indicating “NG”, i.e., a path connection for a test-access is not available is transmitted. Therefore, the administrator (the user) can easily find out that a remote test-access is not implementable.

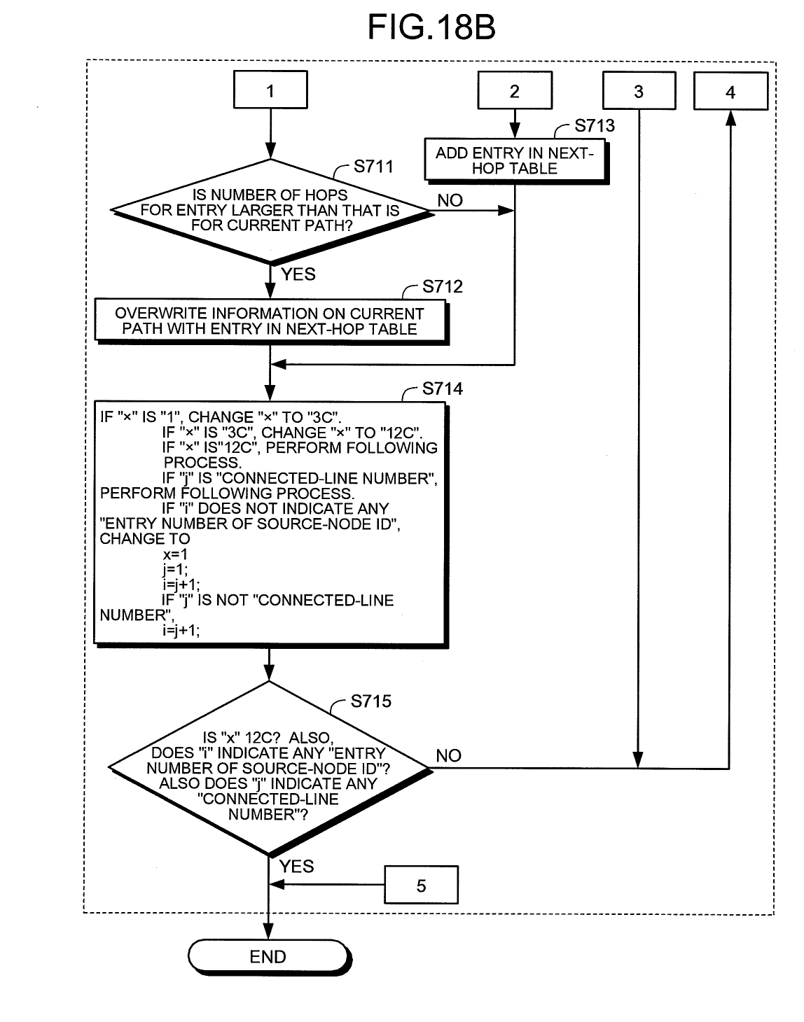

Subsequently, a process of receiving a connection/available-band information notice performed by the transmitting apparatus 100 is explained in detail below with reference to FIGS. 18A and 18B. Incidentally, in this case, when receiving a connection/available-band information notice, the transmitting apparatus 100 updates a next-hop table.

As shown in FIG. 18A, when receiving a test-access PDU via the test-access PDU transmitting/receiving unit 110, the test-access PDU processing unit 120 determines whether a type of the received test-access PDU is a connection/available-band information notice (step S701). If the type of the received test-access PDU is not a connection/available-band information notice (NO at step S701), a process corresponding to the type of the received test-access PDU is performed (step S702).

If the type of the received test-access PDU is a connection/available-band information notice (YES at step S701), the received test-access PDU is duplicated to be spread to the network, and the duplicated test-access PDU is transmitted to all adjacent transmitting apparatuses excluding the one that the test-access PDU is transmitted therefrom (step S703). Then, the test-access routing table 130 is updated based on the received test-access PDU (step S704).

Subsequently, a next-hop table updating process is performed as follows. First, an index “i”, which is used for detecting a source-node ID from the test-access routing table 130, is initialized to “1” (step S705), and an index “j”, which is used for detecting a line of each transmitting apparatus from the test-access routing table 130, is initialized to “1” (step S706). Then, a bandwidth of a test-access path, as indicated by “width”, is initialized to the “STS1”, i.e., a level of the bandwidth, as indicated by “x”, is initialized to “1” (step S707).

Then, it is determined whether a bandwidth corresponding to the “width” can be secured in the j-th line of a transmitting apparatus corresponding to the i-th source-node ID in the test-access routing table 130 (step S708). If the bandwidth can be secured (YES at step S708), it is repeatedly checked whether a line with a bandwidth corresponding to the “width” can be secured in a transmitting apparatus connected to the j-th line, and it is determined whether it is possible to get finally to the own transmitting apparatus (step S709). In other words, it is determined whether there is a path with a bandwidth corresponding to the “width” from the transmitting apparatus having the i-th source-node ID in the test-access routing table 130 to its own transmitting apparatus.

If there is the path (YES at step S709), it is determined whether there is an entry for the transmitting apparatus having the i-th source-node ID in a next-hop table (step S710). If there is the entry in the next-hop table (YES at step S710), it is determined whether the number of hops for the entry is larger than that is for the current path (step S711).

If the number of hops for the entry is larger than that is for the current path (YES at step S711), the entry in the next-hop table is overwritten with information on the current path because a path with a smaller number of hops is to be registered in the next-hop table (step S712).

If there is no entry for the transmitting apparatus having the i-th source-node ID in the next-hop table (NO at step S710), information on a path, which is newly-obtained by the detection, is added into the next-hop table (step S713).

Then, in a case in which a level “x” of the bandwidth is “1”, the level “1” is changed to “3C”, and the process control returns to step S708, and then a line with a bandwidth for the STS3C is detected. In a case in which a level “x” of the bandwidth is “3C”, the level “3C” is changed to “12C”, and the process control returns to step S708, and then a line with a bandwidth for the STS12C is detected. In a case in which a level “x” of the bandwidth is “12C”, if “j” does not indicate “a connected-line number”, i.e., if there is any undetected line, “j” is incremented by “1”. Furthermore, in the case in which a level “x” of the bandwidth is “12C”, if “j” indicates a “connected-line number”, i.e., if there is no undetected line, and also if “i” does not indicate any “entry number of a source-node ID”, i.e., if there is any undetected transmitting apparatus, “i” is incremented by “1”, and both “j” and “x” are initialized to “1”(step S714).

Then, it is determined whether a level “x” of the bandwidth is “12C”, and whether “i” indicates any “entry number of a source-node ID”, and also whether “j” indicates any “connected-line number” (step S715). If all the above conditions are fulfilled (YES at step S715), the next-hop updating process is terminated. If any of the above conditions are not fulfilled (NO at step S715), the process control returns to step S708. Namely, it is determined whether each of the transmitting apparatuses registered in the test-access routing table 130 can be connected to other transmitting apparatus in each of the bandwidths for the “STS1”, “STS3C”, and “STS12C”.

In this manner, when receiving a connection/available-band information notice, the test-access PDU processing unit 120 updates the test-access routing table 130. As a result, the transmitting apparatus 100 can hold the latest information on a connection status and available band in the network constantly.

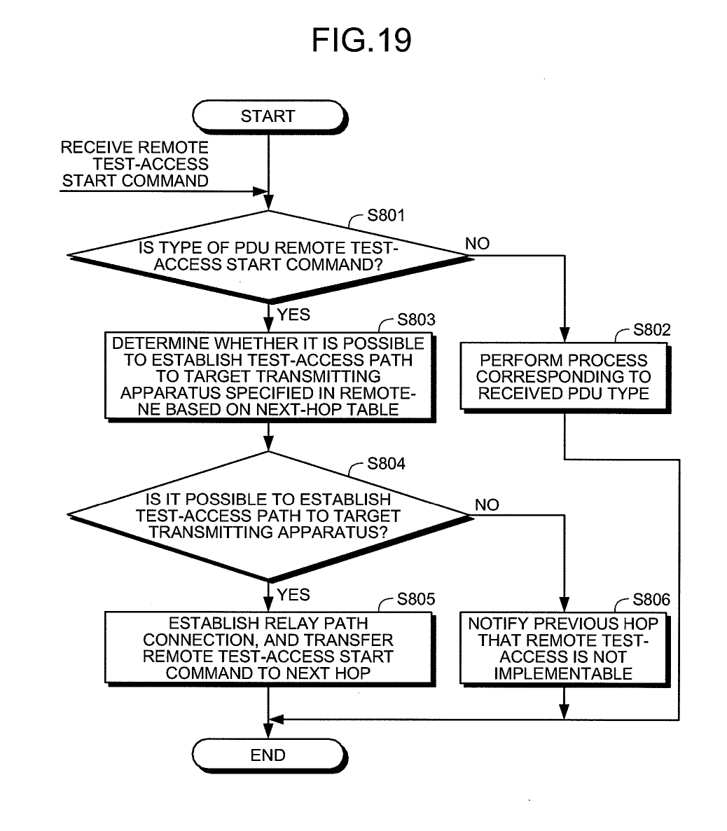

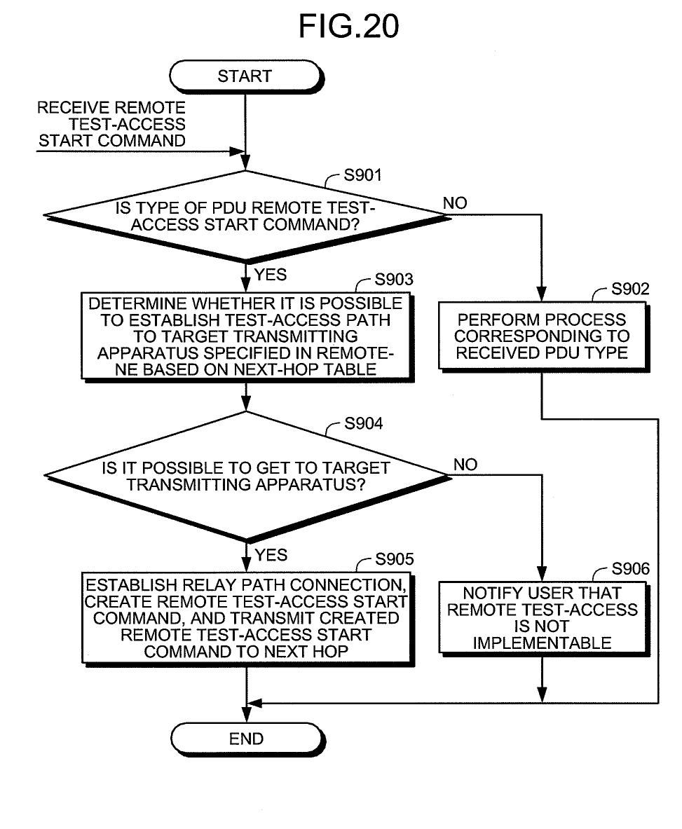

Subsequently, a process of receiving a remote test-access start command performed by the transmitting apparatus 100 is explained in detail below with reference to FIGS. 19 and 20. FIG. 19 is a flowchart of the process of receiving a remote test-access start command in a case in which the transmitting apparatus 100 serves as a relay node.

When receiving a test-access PDU via the test-access PDU transmitting/receiving unit 110, the test-access PDU processing unit 120 determines whether a type of the received test-access PDU is a remote test-access start command (step S801). If the test-access PDU is not a remote test-access start command (NO at step S801), a process corresponding to a type of the received test-access PDU is performed (step S802).

If the test-access PDU is a remote test-access start command (YES at step S801), it is determined whether it is possible to establish a test-access path to a target transmitting apparatus specified in REMOTE-NE based on the next-hop table (steps S803 and S804).

If it is possible to establish a test-access path to the target transmitting apparatus (YES at step S804), the test-access PDU processing unit 120 instructs the test-access processing unit 150 to connect a path to that is in a next hop as a relay path, and also instructs the test-access PDU transmitting/receiving unit 110 to transfer the remote test-access start command to the next hop (step S805).

If it is not possible to establish a test-access path to the target transmitting apparatus (NO at step S804), the test-access PDU processing unit 120 instructs the test-access PDU transmitting/receiving unit 110 to notify a transmitting apparatus that the test-access PDU is transmitted therefrom that a remote test-access is not implemented (step S806).

In this manner, each of the transmitting apparatuses establishes a relay path to a next hop by relaying a remote test-access start command, and thereby establishing a test-access path autonomously.

FIG. 20 is a flowchart of a process of receiving a remote test-access start command issued by a transmitting apparatus where a user's instruction is input.

When receiving a command from a user, the management-command processing unit 140 outputs the received command to the test-access PDU processing unit 120. When receiving the command from the management-command processing unit 140, the test-access PDU processing unit 120 determines whether the received command is a remote test-access start command (step S901). If the command is not a remote test-access start command (NO at step S901), a process corresponding to a type of the received command is performed (step S902).

If the command is a remote test-access start command (YES at step S901), it is determined whether it is possible to establish a test-access path to a target transmitting apparatus specified in REMOTE-NE based on the next-hop table (steps S903 and S904).

If it is possible to establish a test-access path to the target transmitting apparatus (YES at step S904), the test-access PDU processing unit 120 instructs the test-access processing unit 150 to connect a path to that is in a next hop as a relay path, and also creates a remote test-access start command, and then instructs the instructs the test-access PDU transmitting/receiving unit 110 to transmit the created remote test-access start command to the next hop (step S905).

If it is not possible to establish a test-access path to the target transmitting apparatus (NO at step S904), the test-access PDU processing unit 120 instructs the management-command processing unit 140 to notify the user that a remote test-access is not implementable (step S906).

In this manner, when receiving a command for starting a remote test-access from the user, the transmitting apparatus creates a remote test-access start command, and transmits the created remote test-access start command to a next hop. Therefore, it is possible to establish a test-access path autonomously.

As described above, according to the first embodiment, information on a connection status and a band usage status of the network is stored in the test-access routing table 130, and when receiving a remote test-access start command via the test-access PDU transmitting/receiving unit 110, the test-access PDU processing unit 120 detects a test-access path to a target transmitting apparatus including a target path to be tested based on the test-access routing table 130, and instructs the test-access processing unit 150 to establish a path connection in accordance with the detected test-access path, and also instructs the test-access PDU transmitting/receiving unit 110 to transfer the remote test-access start command to a next hop. Therefore, it is possible to establish a test-access path from the test-access testing facility 10 to the target transmitting apparatus autonomously.

Incidentally, the remote test-access function of the transmitting apparatus as described above can be realized in software, and thereby achieving a transmitting-apparatus testing program. A transmitting-apparatus testing program according to a second embodiment of the present invention is described below.

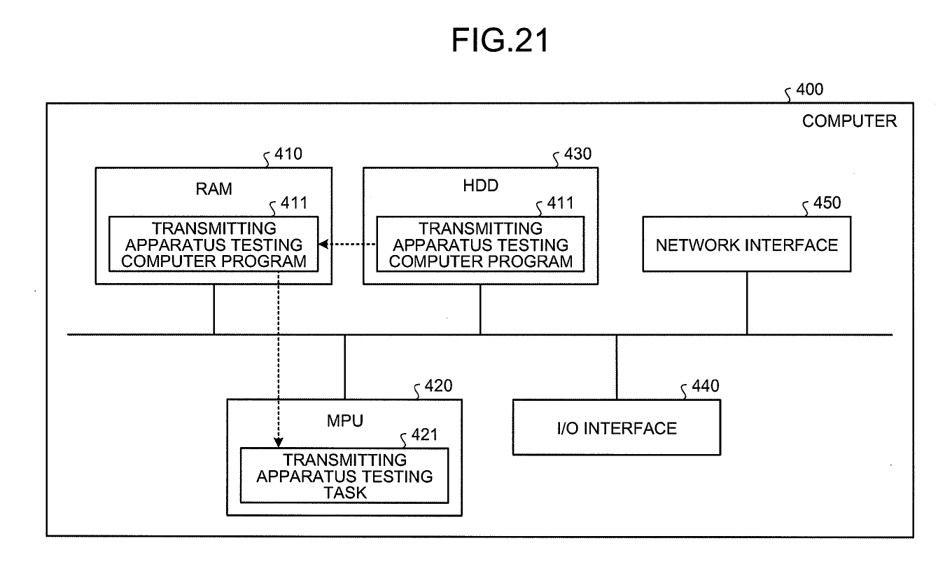

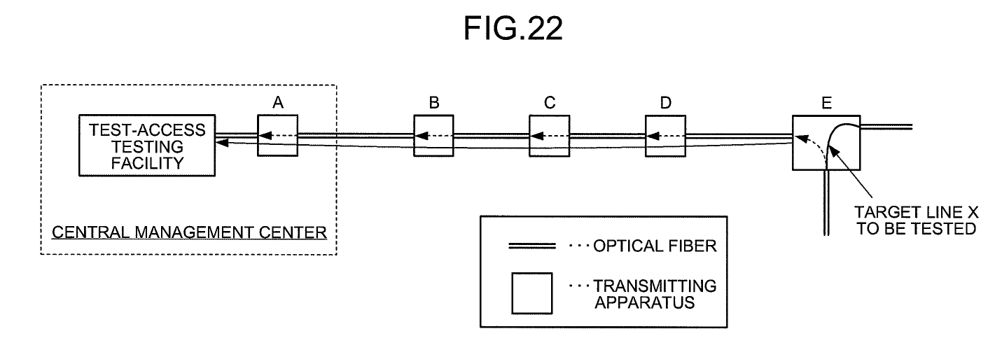

FIG. 21 is block diagram of a computer 400 that executes a transmitting-apparatus testing program 411 according to the second embodiment. The computer 400 includes a random access memory (RAM) 410, a micro processing unit (MPU) 420, a hard disk drive (HDD) 430, an input/output (I/O) interface 440, and a network interface 450.

The RAM 410 is a memory for storing therein a program and a processing result of the program. The MPU 420 is a central processing unit where a program is read and executed. The HDD 430 is a disk unit for storing therein a program or data. The I/O interface 440 is an interface for connecting an input unit, such as a mouse or a keyboard, or a display unit to the computer 400. The network interface 450 is an interface for connecting the computer 400 to the network.

The transmitting-apparatus testing program 411 is installed on the HDD 430. Alternatively, the transmitting-apparatus testing program 411 can be stored in a database of other computer system connected to the computer 400 via the network interface 450, and installed on the computer 400 by being retrieved from the database.

The transmitting-apparatus testing program 411 is read from the HDD 430, and stored in the RAM 410. Then, the transmitting-apparatus testing program 411 is executed by the MPU 420 as a transmitting-apparatus testing task 421.

As described above, according to one aspect of the present invention, each of the transmitting apparatuses autonomously establishes a test-access path. Thus, the test-access testing facility can perform a remote test efficiently.

Furthermore, according to another aspect of the present invention, any changes of the network composition are reflected in information for detecting the test-access path. Thus, even if the network composition is changed, each of the transmitting apparatuses can autonomously establish the test-access path appropriately.

Moreover, according to still another aspect of the present invention, each of the transmitting apparatuses can autonomously establish the test-access path by detecting the most appropriate test-access path based on the information.

Furthermore, according to still another aspect of the present invention, the network administrator can easily find out that either there is a problem to establish the test-access path, or a target path to be tested has a problem. Thus, the test-access testing facility can perform a remote test efficiently.

Moreover, according to still another aspect of the present invention, a request for establishing the test-access path can be transferred among the transmitting apparatuses. Thus, each of the transmitting apparatuses can autonomously establish the test-access path appropriately.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A transmitting apparatus comprising:
an information storing unit that stores therein information on a connection status of transmitting apparatuses in a network and a usage status of a line between the transmitting apparatuses as access-path detecting information; and
a path establishing unit that establishes a test communication path having a predetermined bandwidth for a test communication between a test-access testing facility and a target transmitting apparatus to be tested by the test-access testing facility via the network, based on the access-path detecting information stored in the information storing unit.

2. The transmitting apparatus according to claim 1, further comprising:
an information exchanging unit that exchanges the access-path detecting information for creating the access-path detecting information to be stored in the information storing unit with other transmitting apparatus; and
an information updating unit that updates the access-path detecting information based on the access-path detecting information exchanged by the information exchanging unit.

3. The transmitting apparatus according to claim 1, wherein the information storing unit stores therein information on an adjacent transmitting apparatus that has a path to other transmitting apparatus and is adjacent to the transmitting apparatus in association with a usage status of a connection path with the adjacent transmitting apparatus, as the access-path detecting information.

4. The transmitting apparatus according to claim 1, wherein upon receiving a request for establishing the test communication path from an adjacent transmitting apparatus, the path establishing unit establishes the test communication path by detecting an optimum path to a target transmitting apparatus based on the access-path detecting information and transferring the request to a next adjacent transmitting apparatus along a detected optimum path.

5. The transmitting apparatus according to claim 1, further comprising a pre-confirming unit that confirms in advance whether the test communication path can be established by the path establishing unit.

6. The transmitting apparatus according to claim 1, wherein
the network is a synchronous optical network/synchronous digital hierarchy network, and
the path establishing unit establishes the test communication path by receiving a request for establishing the test communication path from an adjacent transmitting apparatus by using a J1 byte in a path overhead.

7. The transmitting apparatus according to claim 1, wherein the path establishing unit establishes the test communication path by receiving a request for establishing the test communication path from an adjacent transmitting apparatus by using a service access point that is newly defined in a network selector of a connectionless network services protocol in an open systems interconnection protocol.

8. The transmitting apparatus according to claim 1, wherein the path establishing unit establishes the test-access path by receiving a request for establishing the test communication path from an adjacent transmitting apparatus by using a port number that is defined in a transmission control protocol or a user datagram protocol in an Internet protocol.

9. A method of testing a transmitting apparatus, comprising:
storing information on a connection status of transmitting apparatuses in a network and a usage status of a line between the transmitting apparatuses as access-path detecting information; and
establishing a test communication path having a predetermined bandwidth for a test communication between a test-access testing facility and a target transmitting apparatus to be tested by the test-access testing facility via the network, based on the access-path detecting information stored at the storing.

10. A computer-readable recording medium that stores therein a computer program for testing a transmitting apparatus, the computer program causing a computer to execute:
storing information on a connection status of transmitting apparatuses in a network and a usage status of a line between the transmitting apparatuses as access-path detecting information; and
establishing a test communication path having a predetermined bandwidth for a test communication between a test-access testing facility and a target transmitting apparatus to be tested by the test-access testing facility via the network, based on the access-path detecting information stored at the storing.
